(19) United States
(12) Patent Application Publication
(10) Pub. No.: US 2018/0089781 A1
(43) Pub. Date: Mar. 29, 2018

(54) SYSTEMS AND METHODS FOR CENTRALIZED HEALTHCARE COORDINATION AND MANAGEMENT

(71) Applicant: Meta Clinic, LLC, Raleigh, NC (US)

(72) Inventors: Brett Landrum, New Orleans, LA (US); Ramsey Kilani, Raleigh, NC (US); Stephen M. Tanguis, Metairie, LA (US); Franklin Davenport, Baton Rouge, LA (US)

(73) Assignee: Meta Clinic, LLC, Raleigh, NC (US)

(21) Appl. No.: 15/715,064

(22) Filed: Sep. 25, 2017

Related U.S. Application Data
(60) Provisional application No. 62/399,187, filed on Sep. 23, 2016.

(51) Int. Cl. G06Q 50/22; G06Q 30/02; G06Q 10/06

(52) U.S. Cl. CPC G06Q 50/22; G06F 3/04842; G06Q 10/06315; G06Q 30/0282

(57) ABSTRACT

Service provider information of each of a plurality of different service providers may be obtained. A service provider score may be calculated for each of the plurality of different service providers based on the service provider information. A subset of service providers may be selected from the plurality of different service providers based on the service provider scores. At least a portion of the service provider information for each of the subset of service providers may be provided for display through a graphical user interface (GUI). A selection of a particular service provider from the subset of service providers may be received through the GUI. An order may be generated for a particular healthcare laboratory service. A status of the particular healthcare laboratory service may be tracked. A notification of the status of the particular healthcare laboratory service may be provided to the healthcare provider.

### CROSS-REFERENCE TO RELATED APPLICATIONS

The present application claims priority to U.S. Provisional Patent Application Ser. No. 62/399,187, filed Sep. 23, 2016 and entitled “Systems and Methods for Provider/Clinic Marketplace,” which is hereby incorporated by reference herein.

### TECHNICAL FIELD

This disclosure pertains to systems for healthcare management. More specifically, this disclosure pertains to systems for centralized healthcare coordination and management.

### BACKGROUND

The current clinical laboratory testing market is highly fragmented and inefficient, which creates technical, clinical and financial problems for healthcare providers (e.g., physicians and/or other healthcare professionals), service providers (e.g., laboratory testing facilities, billing services), and/or patients.

### SUMMARY

A claimed solution rooted in computer technology overcomes problems specifically arising in the realm of computer technology. In various embodiments, a computing system is configured to coordinate interaction (e.g., direct interaction) between healthcare providers, service providers, and/or patients. For example, the computing system may gather service provider information (e.g., service provider names, offered services, service prices) from a variety of different service providers, calculate scores for each of the service providers, and determine a set of suitable service providers, based on their scores, from which a user (e.g., a healthcare provider) can select to perform one or more healthcare services. For example, scores may be calculated based on service prices, average turnaround times for services, geographic proximity to a user (e.g., a healthcare provider), and/or the like. A user may coordinate directly with the service provider and/or other entities (e.g., payers, patients) through the centralized healthcare management server system to select a particular service provider, order services, receive test results, provide billing and invoicing information, and/or the like. This may allow, for example, healthcare providers, service providers, and/or patients to coordinate with each other without requiring additional intermediary systems, which may add technical complexities and/or require additional resources (e.g., computing resources, user time).

Various embodiments of the present disclosure include systems, methods, and non-transitory computer readable media are configured to obtain service provider information of each of a plurality of different service providers Each of the service providers may be capable of providing one or more healthcare laboratory services. The service provider information may be obtained over a communication network from service provider systems of the plurality of different service providers. The service provider information may be stored. A service provider score may be calculated for each of the plurality of different service providers based on the service provider information. A subset of service providers may be selected from the plurality of different service providers based on the service provider scores. At least a portion of the service provider information for each of the subset of service providers may be provided for display through a graphical user interface (GUI). A selection of a particular service provider from the subset of service providers may be received. The selection may be received through the graphical user interface from a healthcare provider. An order may be generated for a particular healthcare laboratory service of the one or more healthcare laboratory services capable of being provided by the particular service provider. A status of the particular healthcare laboratory service may be tracked. The healthcare provider may be notified of the status of the particular healthcare laboratory service.

In some embodiments, each of the service provider information of the plurality of different service providers includes a respective service provider identifier, a respective healthcare laboratory service identifier for each of the one or more healthcare laboratory services capable of being provided, a respective price for each of the one or more healthcare laboratory services capable of being provided, and a respective service provider geolocation.

In some embodiments, the systems, methods, and non-transitory computer readable media further configured to determine a respective average turnaround for each of the one or more healthcare laboratory services capable of being provided by the service providers, wherein the service information includes the respective average turnaround time.

In some embodiments, the systems, methods, and non-transitory computer readable media further configured to determine a feedback rating for at least one of the plurality of different service providers based on feedback provided by one or more healthcare providers through the graphical user interface, wherein the service provider information includes the feedback rating.

In some embodiments, the systems, methods, and non-transitory computer readable media further configured to identify a particular subset of service providers from the plurality of different service providers based on search criteria, the search criteria received by the centralized healthcare management server system from the healthcare provider through the graphical user interface. In some embodiments, the search criteria includes a desired service provide geolocation, a desired price range of a particular set of one or more healthcare laboratory services, desired range of feedback ratings, and service provider times of operation

In some embodiments, the systems, methods, and non-transitory computer readable media further configured to receive service result data from the particular servicer provider of the subset of service providers; generate a report based on the received service result data; and provide the report to the healthcare provider over the communication network, the report capable of being viewed through the graphical user interface.

In some embodiments, the status of the particular healthcare laboratory service comprises a dynamic status capable of being updated, by the centralized healthcare management server system, in response to one or more trigger events detected by the centralized healthcare management server system, the dynamic status including a plurality of different stages of the particular healthcare laboratory service.

In some embodiments, the centralized healthcare management server system hooks into a service provider system of the particular service provider to detect the one or more trigger events, the one or more trigger events includes a progression from a first stage of the plurality of different stages of the particular healthcare laboratory service to a second stage of the plurality of different stages of the particular healthcare laboratory service.

In some embodiments, the status of the particular healthcare laboratory service includes a shipping status of a specimen associated with the particular healthcare laboratory service.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example system for centralized healthcare coordination and management according to some embodiments.

FIG. 2 depicts a flowchart of an example of a method of centralized healthcare coordination and management according to some embodiments.

FIG. 3 depicts a diagram of an example of a centralized healthcare management server system according to some embodiments.

FIG. 4 depicts a flowchart of an example of a method of operation of a centralized healthcare management server system according to some embodiments.

FIG. 5 depicts a flowchart of an example of a method of centralized searching of aggregated service provider information according to some embodiments.

FIG. 6 depicts an example graphical user interface (GUI) displaying a centralized healthcare marketplace according to some embodiments.

FIG. 7 depicts an example graphical user interface (GUI) displaying an example service offering of a service provider according to some embodiments.

FIG. 8 depicts an example graphical user interface (GUI) displaying a service provider registration screen according to some embodiments.

FIGS. 9A-B depicts example graphical user interfaces (GUIs) displaying an example ordering process according to some embodiments.

FIG. 10 depicts a flowchart of an example method of laboratory processing according to some embodiments.

FIGS. 11A-C depict example graphical user interfaces (GUIs) displaying tracking information according to some embodiments.

FIG. 12 depicts example graphical user interfaces (GUIs) displaying quality control information according to some embodiments.

FIG. 13 depicts an example graphical user interface (GUI) displaying a screen for releasing reports according to some embodiments.

FIG. 14 depicts an example billing rule according to some embodiments.

FIGS. 15A-D depict flowcharts of example billing processes and entity relationships according to some embodiments.

FIG. 16 is a diagram of an example computer system for implementing the features disclosed herein according to some embodiments.

### DETAILED DESCRIPTION

The current clinical laboratory testing market is highly fragmented and inefficient, which creates technical, clinical and financial problems for healthcare providers (e.g., physicians and/or other healthcare professionals), patients, and/or service providers (e.g., laboratory testing facilities, billing services). In some embodiments, a centralized healthcare management server system allows healthcare providers to search for, and connect directly with, service providers offering particular services (e.g., laboratory testing, billing services, test results reports, and/or other resources). Service providers may register with the centralized healthcare management server system to provide service provider information (e.g., (e.g., service provider names, offered services, service prices). The centralized healthcare management server system may present a list of suitable service providers to healthcare providers. In some embodiments, accompanying a service provider's listing may be various metrics, for example, price of services, license identification, geolocation, average turnaround time, and ratings. Some of these metrics may be calculated by the centralized healthcare management server system (e.g., turnaround time and location), while others may be provided by the service providers (e.g., service price, license identification, hours of service). Feedback-based metrics (e.g., customer ratings) may also be calculated from user input by the centralized healthcare management server system and included in the listing.

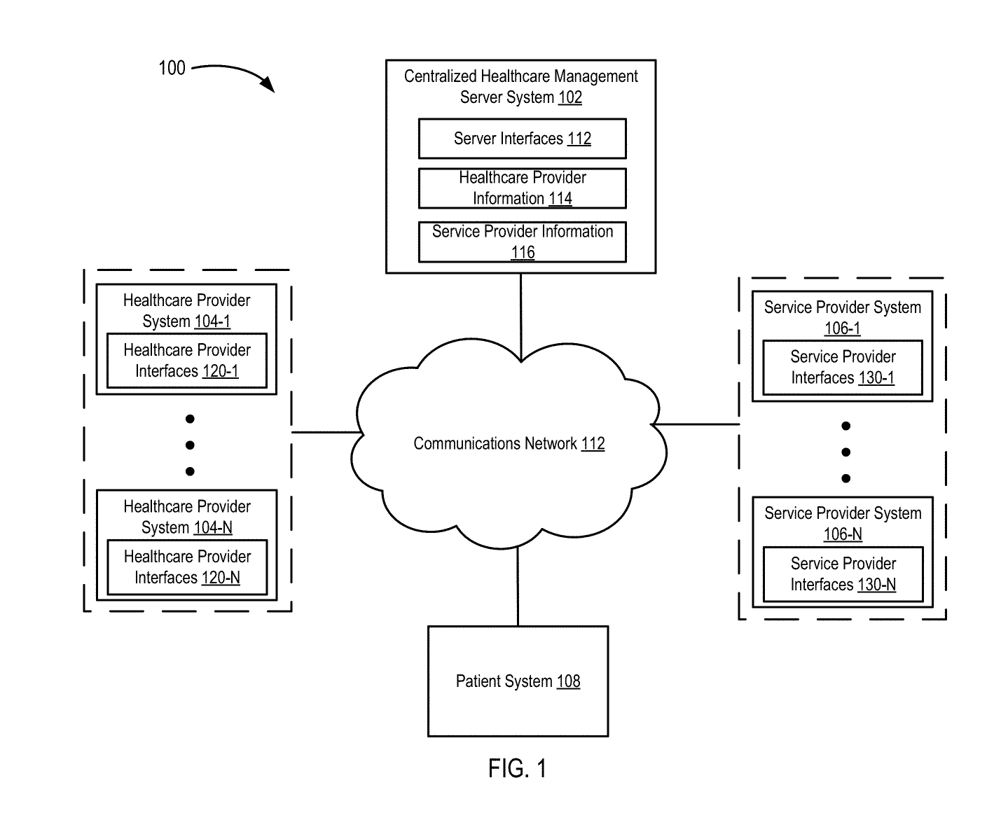

FIG. 1 depicts a diagram 100 of an example system for centralized healthcare coordination and management according to some embodiments. In the example of FIG. 1, the system includes a centralized healthcare management server system 102, healthcare provider systems 104-1 to 104-N (individually, the healthcare provider system 104, collectively, the healthcare provider systems 104), service provider systems 106-1 to 106-N (individually, the service provider system 106, collectively, the service provider systems 106), patient system 108, and a communication network 110.

The centralized healthcare management server system 102 may function to obtain, aggregate, analyze and/or present (e.g., through a web-portal interface) healthcare provider information 114 and/or service provider information 116. Healthcare provider information 114 may include healthcare provider identifiers (e.g., healthcare provider name, healthcare provider NPI, healthcare provider contact information, and/or the like). Service provider information 116 may include service provider identifiers (e.g., name, service provider NPI, service provider contact information, offered services, service prices, turnaround times, service provider scores, feedback ratings, and/or the like). The centralized healthcare management server system 102 may utilize one or more server interfaces 112 to gather information and/or otherwise interact with one or more remote systems. For example, the centralized healthcare management server system 102 may utilize server system interfaces 112 to cooperate with healthcare provider interfaces 120 to gather healthcare provider information 114 from healthcare provider systems 104, and/or utilize server interfaces 112 to cooperate with service provider interfaces 130 to gather service provider information 116 from service provider systems 106. The interfaces described herein may include application programming interfaces (APIs), software development kits (SDKs), source code, machine code, and/or server stubs. In various embodiments, functionality of the centralized healthcare management server system 102 may be performed by one or more servers (e.g., a cloud-based server) and/or other computing devices.

In some embodiments, the centralized healthcare management server system 102 may function to present a set of suitable service providers. The centralized healthcare management server system 102 may determine suitable service providers based on corresponding service provider information 116. For example, different service providers may be presented based on respective scores, locations, offered services, and/or the like. Users (e.g., healthcare providers) may select one or more particular service providers from the set of suitable service providers to handle particular service requests (e.g., without requiring any intermediaries).

In some embodiments, the centralized healthcare management server system 102 may function to generate, store, and/or provide electronic service orders (or, simply, “orders”). For example, the centralized healthcare management server system 102 may receive healthcare provider input regarding order information (e.g., type of service requested, acceptable geographic locations and/or radius, acceptable price ranges, minimum feedback ratings, and/or the like). The centralized healthcare management server system 102 may provide the order to a particular service provider system 106 (e.g., without having to use an intermediary).

In some embodiments, the centralized healthcare management server system 102 may function to track order status. For example, once an order is submitted the centralized healthcare management server system 102 may track shipping status and/or service status. Shipping status may include, for example, status of specimen shipping for a laboratory service test. Service status may include a state of the laboratory service test (e.g., not started, in progress, complete). In some embodiments, the centralized healthcare management server system 102 may utilize server interfaces 112 to cooperate with service provider interfaces 130 to automatically obtain service status information, and/or interfaces of a third-party shipping system (e.g., FedEx).

In some embodiments, the centralized healthcare management server system 102 may function to generate reports and/or other notifications. For example, the centralized healthcare management server system 102 may obtain test result data from service provider systems 106, and automatically generate reports which may be provided to healthcare provider systems 104 and/or patient system 108. In another example, the centralized healthcare management server system 102 may generate notifications regarding order status.

The healthcare provider systems 104 may function to receive, transmit, and/or present data. For example, the healthcare provider systems 104 may interact with the centralized healthcare management server system 102 (e.g., via healthcare provider interfaces 120 and/or server interfaces 112) to displays lists or other structures of suitable service providers, search for particular service provides based on search criteria (e.g., service provider name, particular services, prices ranges, location, feedback ratings, and/or the like). In various embodiments, functionality of the healthcare provider systems 104 may be performed by one or more mobile devices (e.g., smartphones, tablets), laptop computers, desktop computers, servers (e.g., a cloud-based server) and/or other computing devices. The healthcare providers systems 104 may be implemented by a cloud-computing platform (e.g., a healthcare practice/network portal).

The service provider systems 106 may function to provide a variety of different services (e.g., lab services, billing services). The service provider systems 106 may interact with the centralized healthcare management server system 102 (e.g., via server interfaces 112 and/or service provider interfaces 130) to transmit service provider information 116, receive orders, transmit order results, transmit status updates, and/or the like. Service providers systems 106 may be referred to as laborites herein. It will be appreciated that laborites may be referred to laboratory service providers. In some embodiments, functionality of the service provider systems 106 may be performed by one or more servers (e.g., cloud-based servers) and/or other computing devices.

The patient system 108 may function to receive and/or display notifications, reports, and/or the like. Although only one patient system 108 is shown here, it will be appreciated that the centralized healthcare management server system 102 may operate with any number of patient systems 108. In various embodiments, functionality of the patient system 108 may be performed by one or more mobile devices (e.g., smartphones, tablets), laptop computers, desktop computers, servers (e.g., a cloud-based server) and/or other computing devices. For example, the patient system 108 may execute an application (e.g., a web browser and/or a mobile app) to communicate with the centralized healthcare management server system 102 over the communications network 110.

The communications network 110 may represent one or more computer networks (e.g., LAN, WAN, or the like) or other transmission mediums. The communication network 110 may provide communication between systems 102-110 and/or components (e.g., engines, datastores) thereof. In some embodiments, the communication network 110 includes one or more computing devices, routers, cables, buses, and/or other network topologies (e.g., mesh, and the like). In some embodiments, the communication network 110 may be wired and/or wireless. In various embodiments, the communication network 110 may include the Internet, one or more wide area networks (WANs) or local area networks (LANs), one or more networks that may be public, private, IP-based, non-IP based, and so forth.

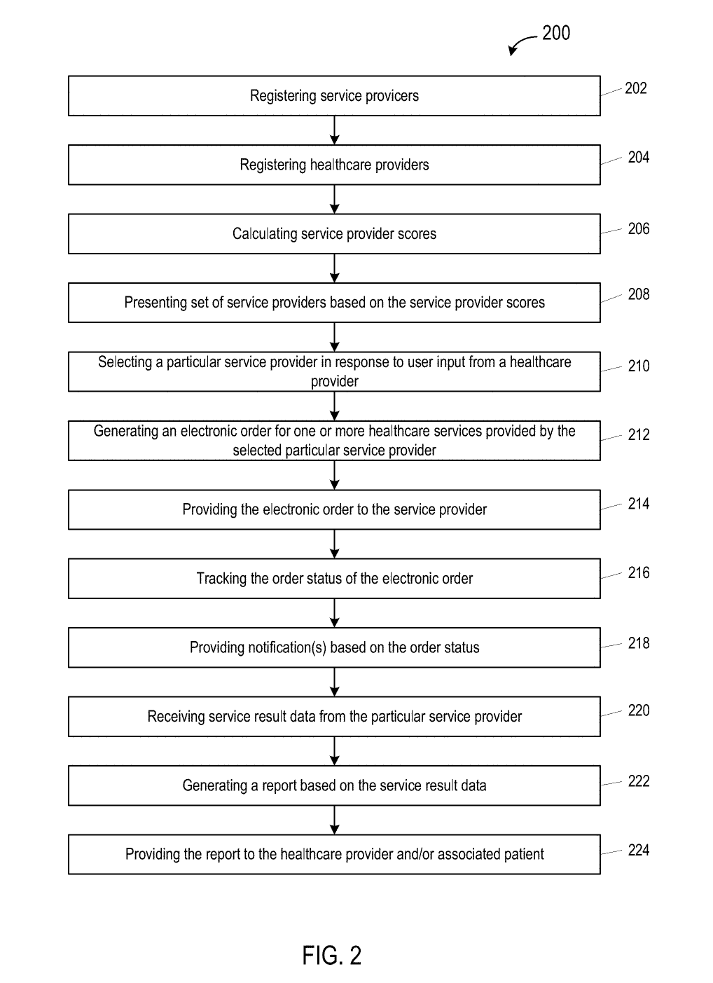

FIG. 2 depicts a flowchart 200 of an example of a method of centralized healthcare coordination and management according to some embodiments. In this and other flowcharts, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

In step 202, a centralized healthcare management server system (e.g., centralized healthcare management server system 102) registers a plurality of different service providers. Service providers may be associated with one or more service provider systems (e.g., service provider systems 106). In step 204, the centralized healthcare management server system registers a plurality of different healthcare providers. Healthcare providers may be associated with one or more healthcare provider systems 104.

In step 206, the centralized healthcare management server system calculates service provider scores. In step 208, the centralized healthcare management server system presents a particular set of service providers based on the service provider scores. In step 210, the centralized healthcare management server system selects particular service provider in response to healthcare provider input. In step 212, the centralized healthcare management server system generates an electronic order for a particular service to be fulfilled by the particular service provider. In step 214, the centralized healthcare management server system provides the order to the particular service provider. In step 216, the centralized healthcare management server system tracks the order status of the electronic order. In step 218, the centralized healthcare management server system provides notification(s) based on order status. In step 220, the centralized healthcare management server system receives service result data (e.g., lab test results) from the particular service provider. In step 222, the centralized healthcare management server system generates a report based on the service result data. In step 224, the centralized healthcare management server system provides the report and/or other notifications to the healthcare provider and/or patient.

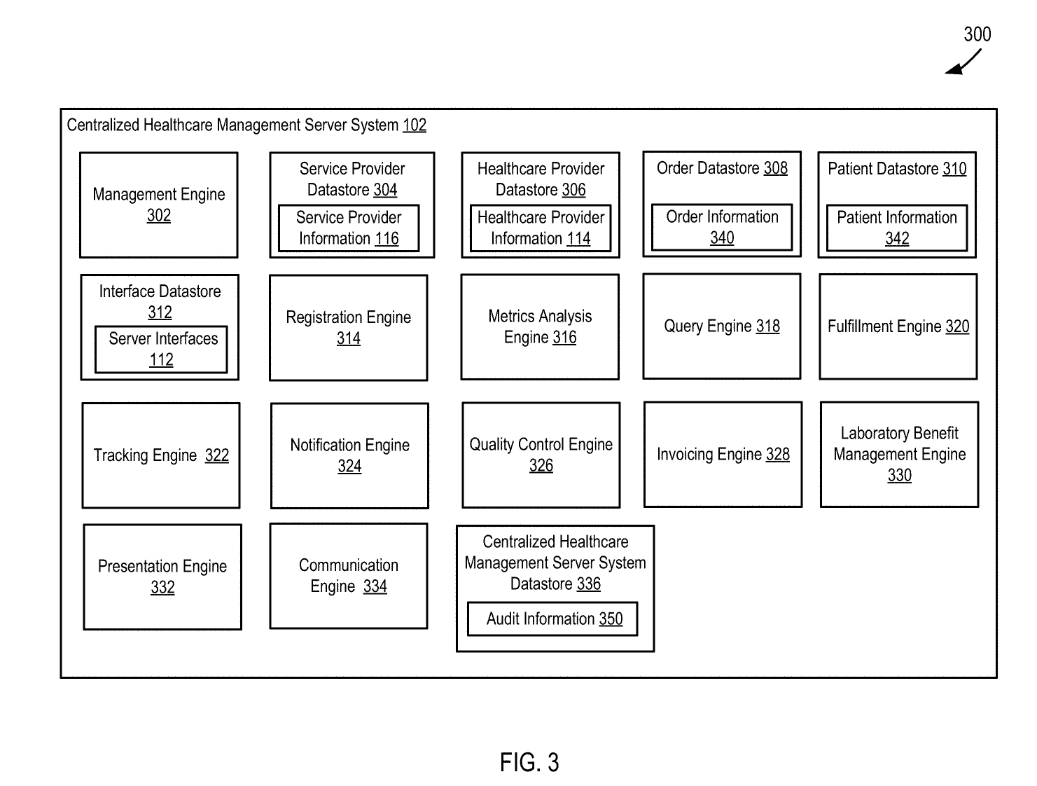

FIG. 3 depicts a diagram 300 of an example of a centralized healthcare management server system 102 according to some embodiments. In the example of FIG. 3, the centralized healthcare management server system 102 includes a management engine 302, a service provider datastore 304, a healthcare provider datastore 306, an order datastore 308, a patient datastore 310, an interface datastore 312, a registration engine 314, a metrics analysis engine 316, a query engine 318, a fulfillment engine 320, a tracking engine 322, a notification engine 324, a quality control engine 326, an invoicing engine 328, a laboratory benefits management engine 330, a presentation engine 332, a communication engine 334, and a centralized healthcare management server system datastore 336.

The management engine 302 may be configured to manage (e.g., create, read, update, delete, or otherwise access) service provider information 116 stored in the service provider datastore 304, healthcare provider information 114 stored in the healthcare provider datastore 306, order information 240 stored in the order datastore 308, patient information 342 stored in the patient datastore 310, server interfaces 112 stored in the interface datastore 312, and/or other information stored in the centralized healthcare management server system datastore 336 (e.g., audit information 350). The management engine 302 may perform any of these operations manually (e.g., by a user interacting with a GUI) and/or automatically (e.g., triggered by one or more of the engines 314-334, discussed herein). In some embodiments, the management engine 302 comprises a library of executable instructions, which are executable by one or more processors for performing any of the aforementioned management operations. Like the other engines described herein, some or all of the functionality of the management engine 302 may be implemented and/or included within one or more other engines.

The registration engine 314 may function to register service providers, healthcare providers, patients, and/or associated systems (e.g., healthcare provider systems 104, service provider systems 106, patient system 108) with accounts of the centralized healthcare management server system 102 (e.g., service provider accounts, healthcare provider accounts, patient accounts). It will be appreciated that reference to service providers, healthcare providers, and/or patients may refer to corresponding entities and/or associated systems. In some embodiments, the registration engine 314 may obtain service provider information 116 from service provider systems 106 manually and/or automatically (e.g., without requiring user input). In some embodiments, the registration engine 314 performs identity verification. For example, upon registration of entities (e.g., service providers, healthcare provider, patients) and/or associated systems, the registration engine 314 may utilize one or more interfaces (e.g., server interfaces 112 and/or third-party interfaces) to automatically look-up and verify a healthcare provider's NPI and/or a service provider's CLIA certification. The registration engine 314 may also use proprietary interfaces (e.g., server interfaces 112) and/or integrate with third-party interfaces and/or technology services to verify the identity of a service provider, healthcare provider, and/or patient (e.g., by using federal identification cross referenced with reports from credit bureaus).

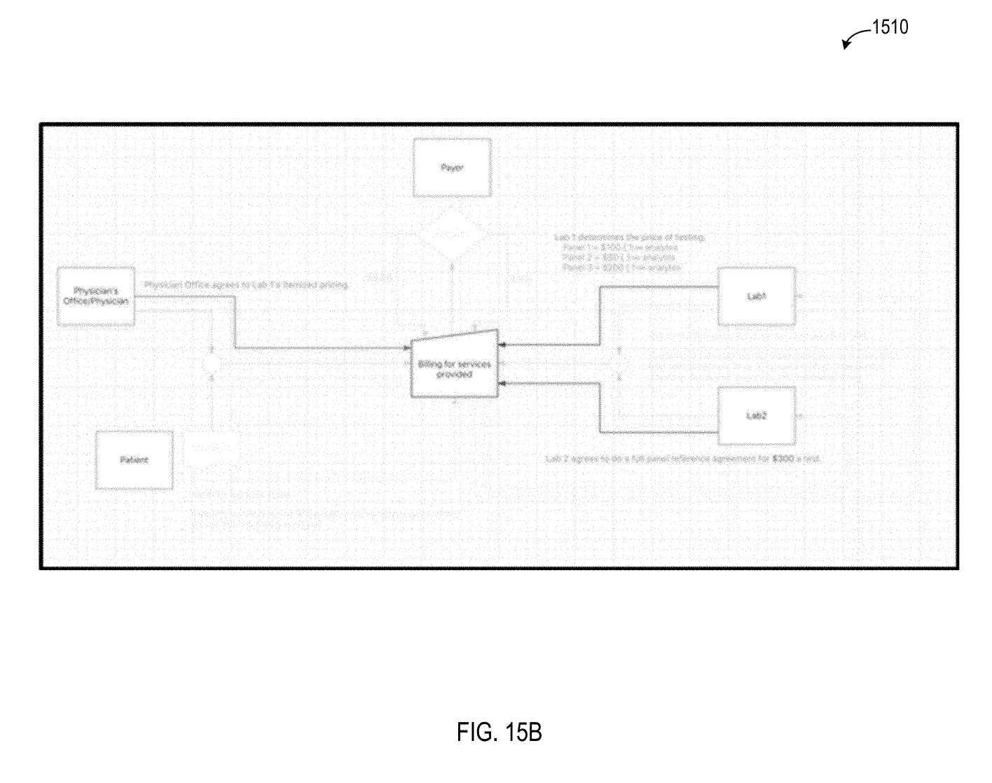

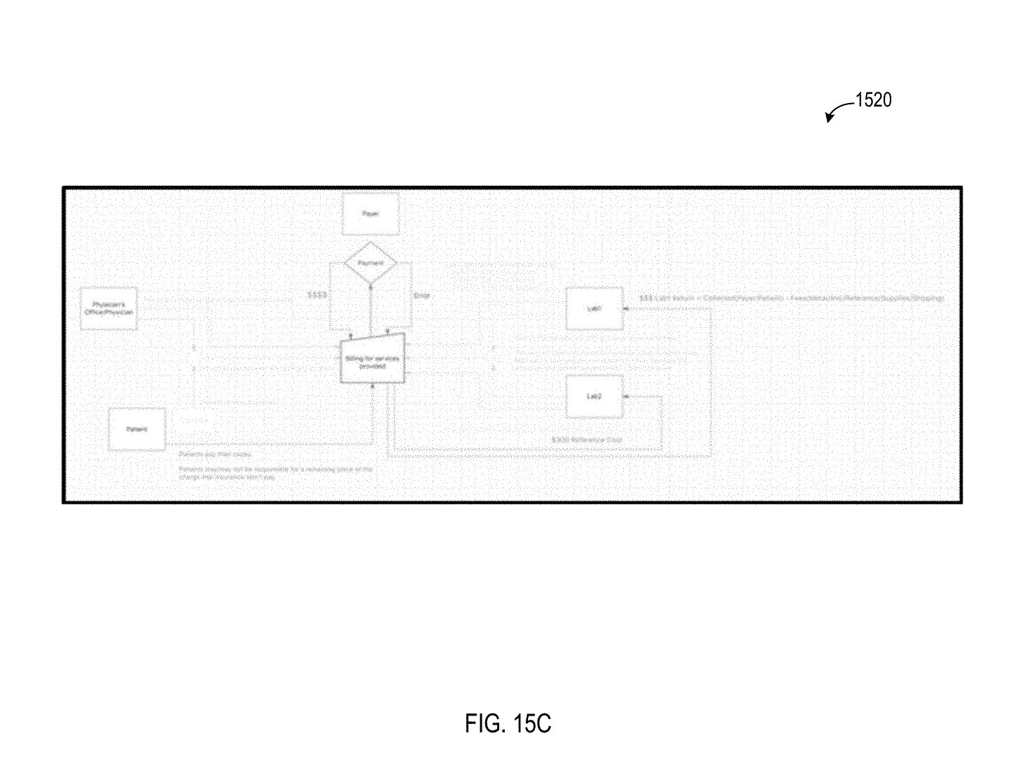

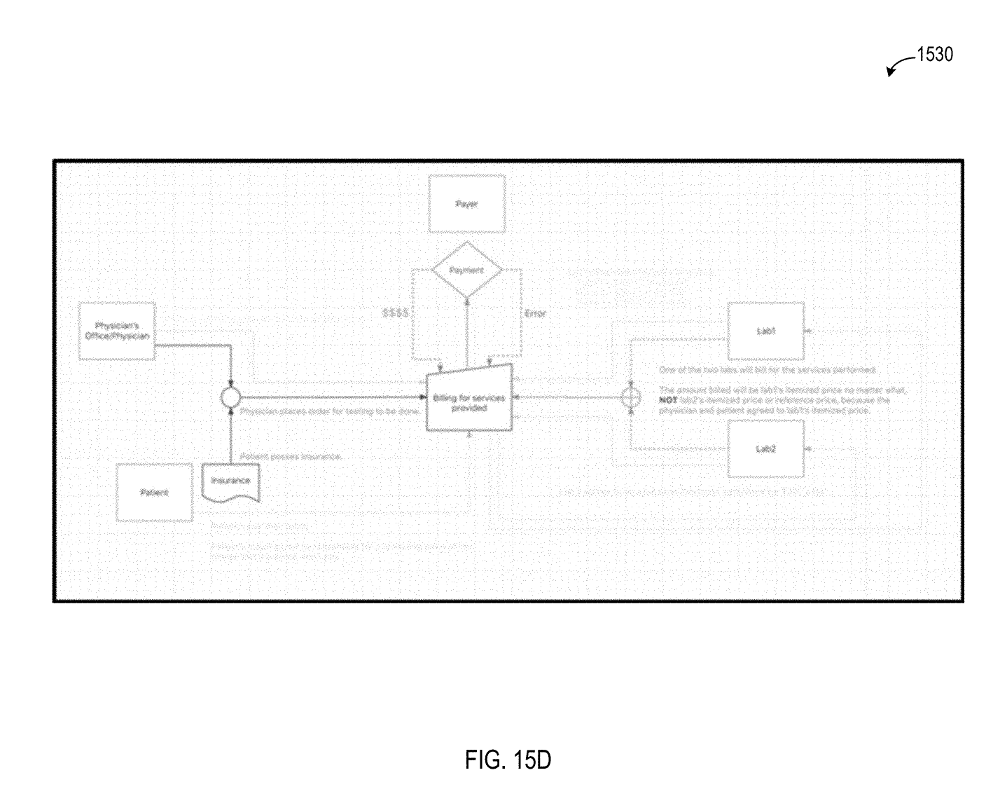

In some embodiments, the registration engine 314 allows service providers to enter their contact information, days of operation, service offerings, and/or other service provider information 116 through a graphical user interface. During the registration (or, “onboarding”) process, the registration engine 314 may extract referral prices agreed upon between service providers for purposes of offering transparency to the transactions for diagnostics. This may include the relational contracts depicted in FIG. 15B.

In some embodiments, service providers may provide (e.g., during and/or after registration) testing services they offer and/or other service provider information 116. It will be appreciated that the registration engine 314 may be used to process to new registrations and/or update existing registrations. In one example, and anatomic pathology laboratory service provider may be able to specify criteria for the types of tissues they are able to process, including but not limited to tissue type, how the tissue was obtained, which part of the body the tissue came from, diseases or conditions which may be diagnosed from the tissue sample, and/or the like. In another example, a toxicology laboratory service provider may specify the medications, compounds, metabolites, and/or other analytes in which they can test for. Service providers may also identify configurations and ranges of detection depending on the sample being tested.

In some embodiments, for the tests and services that the laboratory offers, users (e.g., service providers) may also define fee schedules used to calculate prices to be shown on the marketplace and for billing. Fee schedules may be based on various factors that may or may not be specific (e.g., tailored or tiered and accordingly priced within the centralized healthcare management server system 102) to the report that is requested, such as urgency or the analytes that need to be tested for.

The metrics analysis engine 316 may function to calculate service provider scores and/or other service provider information 116 (e.g., feedback ratings). The metrics analysis engine 316 may calculate service provider scores in real-time and/or periodically. For example, when a healthcare provider logs into their account of the centralized healthcare management server system 102, or searches for a particular service offering, the metrics analysis engine 316 may calculate a current service provider score for available service providers and/or a portion of available service providers (e.g., service providers matching particular criteria, such as geolocation or other parameter(s) of the service provider information 116). For example, service provider scores may be based on some or all service provider information 116, such as service prices, average turnaround times for services, geographic proximity to a user (e.g., am healthcare provider), and/or the like. The metrics analysis engine 316 may calculate average turnaround time based on aggregated empirical/historical data.

The query engine 318 may function to search service provider information 116 for service providers capable of performing various services. For example, the query engine 318 may receive healthcare provider input regarding a specific test, a desired price range, and/or the like, and the query engine 318 may return a set of suitable service providers. The query engine 318 may rank and/or order the set of suitable service providers based on their respective service provider scores.

In some embodiments, the query engine 318 functions to allow healthcare providers to search for available tests and reports and/or other services. The query engine 318 may accept parameters pertaining to the modality and geographic location in order to provide relevant results with accurate pricing information and to ensure that a transaction between the healthcare provider and laboratory follows state, federal, or any other type of regulations. Accepted parameters may include one or more of the following but are not limited to:
Modality
Modality-specific parameters (e.g., For toxicology parameters may be specified for analytes, whether the sample is urine or oral fluid, and cut-off values)
Geographic Location
Price Range
Rating
Days of Operation

The query engine 318, using some or all parameters, may query some or all datastores 304-312 and/or datastore 336 for services which match the specified parameters. For each offering, the query engine 318 may determine if there are any reasons the healthcare provider and service provider may not work together. Any reasons found may be linked to the offering to prevent the transaction from occurring and to inform the healthcare provider of the reasons why. For example, the centralized healthcare management server system 102 datastores may contain tables enumerating the rules of how entities (e.g., service providers) from different states and/or regions may work together. Querying those tables may be used to determine that a certain contract must be in place between the two entities. Other tables may enumerate the contracts between these entities which the query engine 318 has verified to exist. If the query engine 318 cannot verify that the required contract exists, it may inform the healthcare provider accordingly and/or prevent a transaction from occurring between the two entities. The results of the query may converted into applicable data formats and transmitted to a web-client (e.g., of a healthcare provider system 104 and/or a service provider system 106).

The fulfillment engine 320 may function to generate and/or transmit orders. Orders may include order information 340 and may be stored in the order datastore 308. Order information 340 (e.g., collected during an ordering process) may include urgency (e.g., STAT), payer information, patient information, specimen information, shipping label integration, service information, previous diagnosis information, bar code generation, physician testing requests, and/or the like.

In some embodiments, after selecting a service provider, a healthcare provider may accession a case and/or place an order using an order form generated by the fulfillment engine 320. Upon submission of the form(s), the order may be created and appropriate sub components and records under the appropriate account. For example, a record in the case table of order datastore 308 can be created an be populated with the information for this specific order, including auto generated case numbers which are assigned to all cases for lookups, barcode generation, and identification. A patient record 342 may be retrieved from the patient datastore 310 matching the patient selected at the time of order creation and updated to reflect the newest data. If the order is for a new patient, a new patient record may be created in the patient datastore 310 and linked to the case/order record 340. Multiple records can be created for each specimen associated with the order and housed in their own database table. These records can contain all of the appropriate information for identifying and describing the specimen including tissue type (e.g., urine, biopsy, oral fluid), anatomical origin, and number of pieces.

In some embodiments, shipping order numbers can be retrieved via third-party shipping APIs and stored into the record for the order 340. By storying the package's shipping identifier with the case or order and creating a link between the case record and the shipping identifier, the fulfillment engine 320 may use the third party's API to do dynamic lookups to track the shipping status of the order's package, and show the status of directly inside a display (e.g., web-portal) presented by the centralized healthcare management server system 102. The ordering healthcare provider's account identifier or ID can be linked to the case for appropriate access to status updates and the final delivered product. The service provider's account can also be linked to the case upon creation in order to give them appropriate access to the case and specimen information. Upon creation of the order, the order may then appear in the service provider's queue designating the case as in transit and alerting the laboratory of its creation. Via communication integrations including HTTPS API and SFTP HL7, the fulfillment engine 320 may transfer necessary documentation for billing and payment to a billing partner, or a billing division of an entity operating the centralized healthcare management server system 102, as permissible by applicable law(s) and payor contracting, at the time of ordering. Updated information can be re-sent as updates are made to the case during its life cycle. The fulfillment engine 320 may also transfer necessary documentation for processing results to and receive digital resources from participating user organizations such as laboratories via communication integrations to their lab inventory management systems. Proper audit logs 350 may be created denoting which members of each party were the one's creating the records and the time and location the order was created.

In some embodiments, orders placed by the fulfillment engine 320 may be directly transferred into Lab Inventory Management System (LIMS) software of the centralized healthcare management server system 102 by the association created with the laboratory's account at the time of the order creation. Orders and the associated records may also be transferred to a third party LIMS software vendor via communication integrations for service provider to process and queue prior to physical arrival of orders if applicable. Such integrations may be accomplished via various communication protocols including TCP-IP, SFTP, and HTTPS. Data transmitted during integration communication may be arranged in data formats including JSON, SOAP, and HL7. The fulfillment engine 320 can also use integrations to have third party vendors communicate the status of the order back to the centralized healthcare management server system 102 for the appropriate status updates and during certain stages in the process as appropriate.

In some embodiments, the fulfillment engine 320 may check patient insurance eligibility during the ordering process using internal mechanisms or via third party billing services. For example, the fulfillment engine 320 may query patient eligibility direct from the patient's insurance provider by sending a request message in formats including X12 to the insurance provider via communication protocols including HTTPS, TCP-IP, and SFTP. The fulfillment engine 320 may also query patient eligibility by sending a message in various formats including HL7, SOAP, or JSON to external billing services and receive the patient eligibility via a response from the billing service.

The tracking engine 322 may function to shipping status and/or order status. In some embodiments, shipping order information (e.g., shipping order numbers) can be retrieved via third party shipping APIs and stored into the record for the order. By storying the package's shipping identifier with the case or order and creating a link between the case record and the shipping identifier, the tracking engine 322 may interface with the third party API to track the shipping status of the order's package, and show the status of directly by the centralized healthcare management server system 102 (e.g., via a web-portal generated the presentation engine 332). The tracking engine 322 may also store coordinates of various parties involved in workflows and order process and display maps and geolocation visual elements.

The tracking engine 322 may implement and/or utilize process tracking tools such as barcode generation and scanning, motion, proximity, and voice detection can be used to monitor the service provider and/or in-house process of the place of service. The metrics and amount of data collected can be configured separately on a per laboratory basis. Metrics which can be recorded and displayed include the stage of the process the sample is currently at by updating records in the specimen table to denote the appropriate stage or workstation the specimen is at; who, where, and when someone has performed actions to the product. Workstation's at the laboratory can be cataloged into a database table and mechanisms such as cookies can be used to associate what computer is associated to each database record. Upon the creation of an API request, the workstation's identifier can be sent along with the request to designate what action was done at what workstation. By referring to the user currently logged into the system, each API request can be associated with that particular lab personnel. Time stamps can be placed on each request in order to track the date and time the action took place. Specimen log records can be created in a designated database table once a specimen has entered a particular stage of the laboratory process and be populated with the appropriate information to describe the process and any physical changes done to the specimen at that stage and notations created by laboratory personnel.

In some embodiments, instruments used in the process and instrument settings can be tracked by placing barcodes on or around the instruments containing the information about the instrument or setting. Upon scanning of the barcode, database records for the specimen and specimen logs can be updated to reflect the procedures applied to the specimen at that stage in the process.

In some embodiments, temperature, humidity, and other metrics of instruments or environment can be tracked by using third party APIs, WIFI, Ethernet, or serial connections in order to read the appropriate readings off the sensors. Automatic polling can be done to the sensor to read the metrics at specific time intervals or automated triggers provided by the sensor can be used to read metrics outside of normal timeframes.

In some embodiments, by having the association between the healthcare professionals account and the laboratory's accounts to the case or order record, doctors and laboratory staff can monitor the overall progress of shipping and laboratory stages and processes for samples or services through their designated portals.

In some embodiments, each laboratory may have the ability to define the stages of their process. Records can be created for each stage. Physical workstations can be associated with certain stages in the process. The stage ID can be used in order to filter the records a laboratory or doctor sees. Links on the user interface can automatically populate the stage's ID when a user selects that stage, thus denoting a certain page of the user interface as being a part of a specific stage. When a sample or specimen is at a particular stage, the stage's ID can be set on the specimen's record to denote the stage the specimen is at. When a user is at a workstation or on a page designated as being at a certain stage, when a specimen barcode has been scanned or proximity sensors detect the presence of a specimen, the specimen's identifier can be used to look up the appropriate specimen record and update the stage ID associated with that that record. New log records can be created automatically once a specimen or sample enters a new stage.

In some embodiments, each laboratory may have the ability to define custom log formats for each stage in the laboratory process. The formats can be created in order to have the ability to store and track the appropriate information needed by the laboratory to collect at a certain stage in the process. For instance, upon arrival of a sample, the color, size, and overall description of the sample may need to be noted and logged. The format of the log can be stored in a schema-less database structure including PostgreSQL JSON data types and MongoDB document storage for the dynamic and independent creation of log formats. By storing the log format in a schema-less structure, the structures can vary drastically between the various stages and still provide a cohesive mechanism for displaying the logs. JavaScript can be used to iterate through the various fields of the log and change the HTML input types to appropriate type needed for that input field. Additional identifiers can be added to certain input types to provide additional functionality such as turning on and off other fields or pulling in information from other data sources and tables and populate them into the log. JavaScript can look for the identifiers of the input fields and then apply appropriate event handlers and functions to handle the actions needed.

In some embodiments, each laboratory may have the ability to define custom actions that are triggered when special events are detected. For example, when a laboratory cassette is moved into the microtome stage, a trigger may determine that the cassette may need to be divided into two slides, so then it will create two new sample records, propagate the appropriate information from the creating origin to the newly created records, create specimen log and audit log records, generate the appropriate IDs and barcodes for each new sample.

In some embodiments, the centralized healthcare management server system 102 may provide supplies and inventory management for services. For example, specimen containers required for transportation may be dispersed by proprietary supply stores and shipped to locations or ordered via third party vendor integrations. The amount of containers needed for a number of orders or for a set time period can be estimated by cross referencing prospected order volume and the required containers for the relevant orders. Available inventory of a user organization's facility can be tracked by associating a list of required containers to a service offering and updating records to indicate when a container has been designated as used for an order and made no longer available.

In some embodiments, samples or goods arriving to the lab or place of service can be registered that they have arrived to the appropriate destination for processing, through assistance mechanisms including:
By interfacing with an API provided by the shipping carrier, such as UPS or FedEx. The centralized healthcare management server system 102 may periodically poll such a shipping carrier's API for shipping updates or may register with the shipping carrier to receive messages for shipping updates. A database query may find all specimens associated with the shipping number and mark each one with the arrival information.
By allowing the laboratory to scan the shipping label. A database query may find all specimens associated with the shipping number and mark each one with the arrival information.
By allowing the laboratory to scan specimen barcodes. These barcodes would be generated by the centralized healthcare management server system 102, printed at the healthcare provider, and affixed to the specimen before shipping. Once the laboratory scans the barcode into the centralized healthcare management server system 102, a database query may find the specimen associated with the barcode and mark it as arrived.

The notification engine 324 may function to generate and/or provides (collectively, “provide”) reports, alerts, and/or other notifications (collectively, “notifications”). In some embodiments, the notification engine 324 may provide notifications in response to and/or based one or more triggers (e.g., automated triggers). Triggers may be performed at the time of arrival such as:
Moving the specimen records into the appropriate stage as configured by the laboratory's workflow.
Sending emails, SMS messages, or other alerts to involved parties.
Notifying integrated Electronic Medical Record software(EMR or EHR) of status through various means such as HL7 messaging or API integration.

In some embodiments, healthcare providers are able to receive their digital resources such as reports or laboratory results through various mechanisms. First report PDF and/or results may be downloaded directly from centralized healthcare management server system 102 portal web portal via web technologies such as HTML and JavaScript, and for display in mobile applications. Second, the centralized healthcare management server system 102 may be configured to generate and deliver reports automatically in response to certain events. For instance, when all required data to generate a report has been imported into the centralized healthcare management server system 102 and no errors within the data are found, the centralized healthcare management server system 102 may generate the report and place the file on server where an EMR or health provider may accept the report.

The notification engine 324 may also receive digital resources via an integration with participating members. Such integrations may be accomplished via various communication protocols including TCP-IP, SFTP, and HTTPS. Data transmitted during integration communication may be arranged in data formats including JSON, SOAP, and HL7.

In some embodiments, digital resources may also be delivered electronically by the notification engine 324 into an Electronic Medical Records software (EMR or EHR) of the server provider or other entity. For example, the results or report may be encapsulated into an HL7 message and placed into an SFTP folder or sent over an TCP connection or sent via a multipart HTTP Request. How and where the data is delivered may configured based on factors such as the health care provider, patient, or laboratory. Reports can be custom branded in the name of the billing entity (such as the physician, physician-owned lab, or other billing entity) as needed to meet payor criteria for billing.

The quality control engine 326 may function to perform error checking, pre-processing, action prevention, and/or audit logging. In some embodiments, uploaded results data and/or media may be uploaded to the centralized healthcare management server system 102 by the service provider system. During file and/or media upload, data can may converted by the quality control engine 326 into a normalized format for processing. CSVs or other data types can be parsed and the data can be converted into a normalized format that all results data shares allowing for a cohesive display of data consisting of drastically different data types. During processing, the quality control engine 326 may perform error checking and analysis to verify data presence and integrity. Errors may include some or allow of the follow:
Data file corruption
Missing data points can be detected by referring to the report record and it's required data points
Values out of range can be detected by referring to the report record and looking up what is the appropriate format and range the data point requires
Report or offering will be unable to be accurately created with uploaded data
Laboratory not having adequate inventory or means to process a sample.

In some embodiments, depending on the report or service offering, certain pre-processing of results can applied to the result data upon upload.

In some embodiments, action prevention may include some or all of the following:
Case releasing, closing, or product generation won't be allowed if incomplete or with invalid data
Items can be prevented from being able to be scanned or interacted with if inappropriate actions are applied to a specimen or sample. The sample may be frozen in its current state to prevent any further actions until an approved action takes place
By monitoring the sample's progress through the establishment's process and the type of product assigned to the order, samples can be restricted to certain stages and to only allow a sub set of actions take place on them at a given stage.

The quality control engine 326 may perform audit logging. Audit logs 350 may be created and stored in the centralized healthcare management server system datastore 336. In some embodiments, all actions can be recorded and changes logged for analysis and quality control including:
Who, where, and when someone has performed actions to the product.
Time spent at a stage in the process.
Emails generated
Patient demographic or order updates
Billing/Insurance information updates

The invoicing engine 328 may function to generate and/or provide invoices and/or billing. In some embodiments, the invoicing engine 328 provides features (e.g., a portal) through which the ordering healthcare provider can transfer necessary documentation for billing and payment to a billing partner, or a billing division of the centralized healthcare management server system 102 as permissible by applicable law(s) and payer contracting, at the time of ordering. This step may be made required or optional in the ordering process, and may serve as a predicate to processing. The centralized healthcare management server system 102 may also provide a marketplace for providers of billing services, within or external to its platform, as permissible by law.

In some embodiments, through internal billing solutions or third party integrations including billing service (insurance claim submission or patient billing) providers and physician's EMR systems, health care professionals such as doctors and laboratories can privately bill customers or bill insurance companies for the services provided.

In some embodiments, pertinent information required for billing (e.g., insurance claim submission) can be incorporated, exported, or transferred to third party billing companies, through mechanisms such as HL7 messaging via SFTP, HTTPS, or TCP/IP and JSON API integration, to complete the billing process.

In some embodiments, information used or transferred for billing may include patient demographics, insurance Information, claim information, specimen descriptions, physician information, date of service, facility information, physician requests, Services rendered, test codes, and/or diagnosis codes.

In some embodiments, Billing rules may be connected at the point of accessioning to a billing clearinghouse for instant adjudication. We may utilize machine learning to predict the adjudication for the purpose of informing the patient of any potential payment required of them before incurring the cost of the medical procedure.

The invoicing engine 328 may automate or otherwise facilitate invoicing and payments between the parties utilizing the platform for services provided. Either before the order has been completed or after services have been rendered, the entity (NPI) billing (insurance claim or patient bill) for the services can provide payment to the other entities involved (for example: reference laboratory, billing company, and/or centralized healthcare management server system 102) for services provided.

As an example, a toxicology test ordered by a physician billing for the service can be considered. Once the test is processed by a selected laboratory (reference lab or otherwise) and a finalized report is received via the centralized healthcare management server system 102, invoices may be generated by the centralized healthcare management server system 102 on behalf of the entities providing services related to test ordering, performance, results reporting and delivery, and claim submission/billing. These types of arrangements may be determined at the time of services selection at the marketplace or via other agreements between the various parties.

The laboratory benefits management engine 330 may function to utilize data aggregated and/or produced by the centralized healthcare management server system 102 as basis of an LBM functionality that could be purchased, licensed, or otherwise paid for by insurance payers. Specifically, billing filters could be custom configured to accommodate the payment requirements and algorithms of insurance payers. A GUI could be available to the payer to set their own parameters for pre-authorization and/or claim adjudication and payment. Payers could then make participation with the LBM a requirement for some or all entities submitting claims for laboratory services. The centralized healthcare management server system 102 could aggregate each payer's rules into an automated system to allow for pre-adjudication of all patients, regardless of the insurance in question, so long as the insurance payer has provided the MC platform with its own rules for payment.

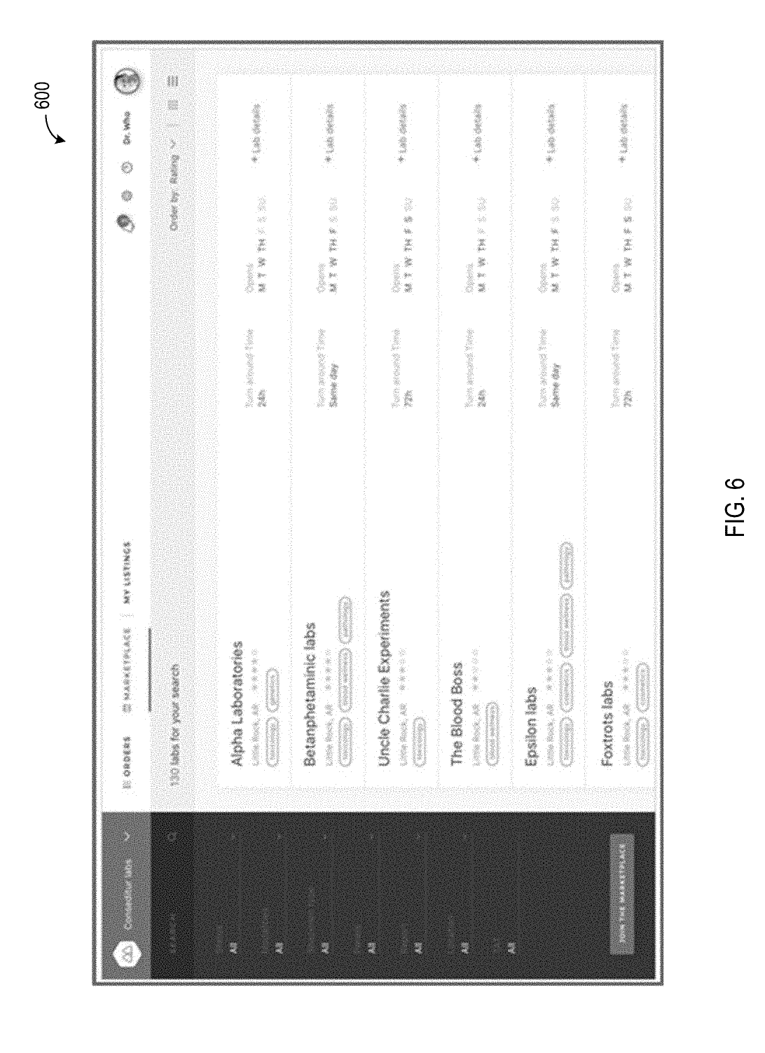

The presentation engine 332 may function to generate displays, present information, receive input, and/or the like. For example, the presentation engine 332 may comprise a server-side engine capable of cooperating with client-side systems to present a web-portal comprising a variety of different interfaces, and otherwise present interfaces to provide the functionality described herein. Example interfaces are shown in FIGS. 6-9 and FIGS. 11-13.

The communication engine 334 may function to send requests, transmit and, receive communications, and/or otherwise provide communication with one or a plurality of systems (e.g., healthcare provider system 104, service provider systems 106, patient system 108). In some embodiments, the communication engine 334 functions to encrypt and decrypt communications. The communication engine 334 may function to send requests to and receive data from one or more systems through a network or a portion of a network. Depending upon implementation-specified considerations, the communication engine 334 may send requests and receive data through a connection, all or a portion of which may be a wireless connection. The communication engine 334 may request and receive messages, and/or other communications from associated systems. Communications may be stored at least temporarily (e.g., cached and/or persistently) in the centralized healthcare management server system datastore 336.

In some embodiments, data may be delivered to and/or received by the communication engine 334 through various mechanisms. Data may be received directly through an application API. For example, a person may upload the data using the a web-client of the centralized healthcare management server system 102, and/or a third-party may use custom software to send the data directly from their systems.

In some embodiments, a data file may be placed a on server or other system which the centralized healthcare management server system 102 has access to. For example, the communication engine 334 may be configured to watch file servers for new data and import the data as soon as new data is found.

The centralized healthcare management server system datastore 336 may function to store, at least temporarily, data received from one or more other systems. For example, the centralized healthcare management server system datastore 336 may store messages received by the communication engine 334. Like other datastores described herein, the centralized healthcare management server system datastore 336 may reside local to the centralized healthcare management server system 102, and/or comprise an associated remote storage system (e.g., a cloud storage system).

In some embodiments, the centralized healthcare management server system datastore 336 stores, temporarily and/or persistently, audit information 350 and/or server interfaces 112.

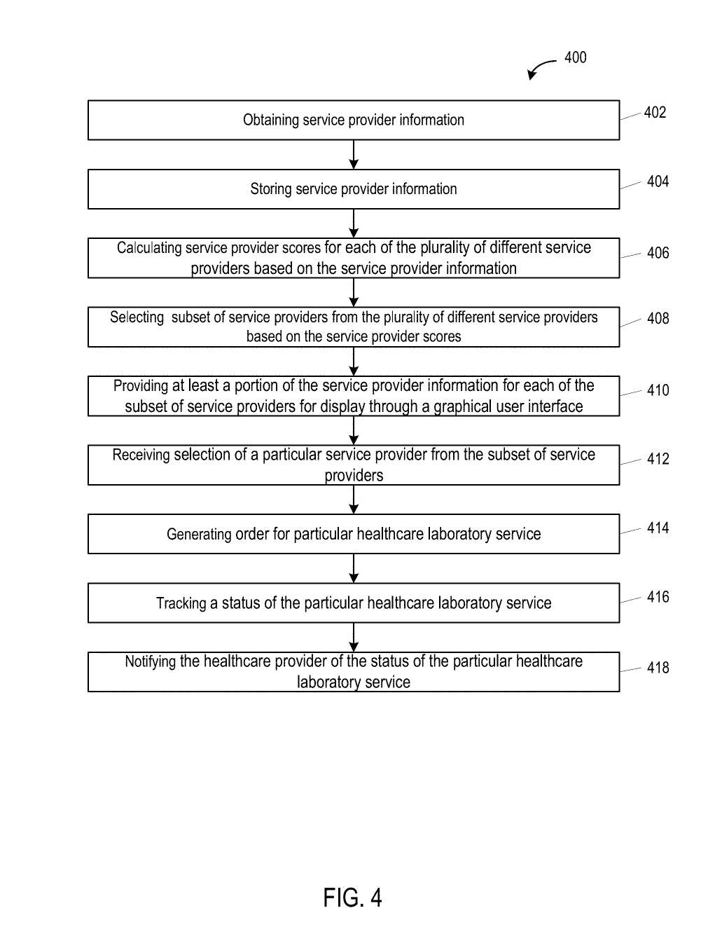

FIG. 4 depicts a flowchart 400 of an example of a method of operation of a centralized healthcare management server system according to some embodiments.

In step 402, a centralized healthcare management server system (e.g., centralized healthcare management server system 102) obtains service provider information (e.g., service provider information 116) of each of a plurality of different service providers (e.g., lab testing service providers). Each of the service providers may be capable of providing one or more services (e.g., healthcare laboratory services). The service provider information may be obtained over a communications network (e.g., communications network 110) from service provider systems (e.g., service provider systems 106) of the plurality of different service providers. For example, each of the service provider information of the plurality of different service providers may include a respective service provider identifier, a respective healthcare laboratory service identifier for each of the one or more healthcare laboratory services capable of being provided, a respective price for each of the one or more healthcare laboratory services capable of being provided, and/or a respective service provider geolocation. In some embodiments, a registration engine (e.g., registration engine 314) and/or a communication engine (e.g., communication engine 334) obtains the service provider information. For example, the communication engine may utilize one or more server interfaces (e.g., one or more server interfaces 112) to cooperate with corresponding service provider interface(s) (e.g., service provider interface(s) 130) to obtain the service provider information.

In some embodiments, the centralized healthcare management server system determines a respective average turnaround for each of the one or more healthcare laboratory services capable of being provided by the service providers. The service provider information may include the respective average turnaround time. In some embodiments, a metrics analysis engine (e.g., metrics analysis engine 316) performs determines the respective average turnaround time(s).

In some embodiments, the centralized healthcare management server system determines a feedback rating for at least one of the plurality of different service providers based on feedback provided by one or more healthcare providers through the graphical user interface. The service provider information may include the feedback rating. In some embodiments, the metrics analysis engine determines the feedback rating(s).

In step 404, the centralized healthcare management server system stores the service provider information. In some embodiments, a management engine (e.g., management engine 302) stores the service provider information in a service provider datastore (e.g., service provider datastore 304).

In step 406, the centralized healthcare management server system calculates a service provider score for each of the plurality of different service providers based on the service provider information. In some embodiments, a metrics analysis engine (e.g., metrics analysis engine 316) calculates the service provider score.

In step 408, the centralized healthcare management server system selects a subset of service providers from the plurality of different service providers based on the service provider scores. In some embodiments, the metrics analysis engine selects the subset of service providers.

In step 410, the centralized healthcare management server system provides at least a portion of the service provider information for each of the subset of service providers for display through a graphical user interface (GUI). The GUI may be at least partially generated by the centralized healthcare management server system. In some embodiments, a presentation engine (e.g., presentation engine 332) generates the GUI and/or provides the service provider information.

In step 412, the centralized healthcare management server system receives a selection of a particular service provider from the subset of service providers. The selection may be received through the graphical user interface from a healthcare provider. In some embodiments, the presentation engine receives the selection.

In step 414, the centralized healthcare management server system generates an order for a particular healthcare laboratory service of the one or more healthcare laboratory services capable of being provided by the particular service provider. In some embodiments, a fulfillment engine (e.g., fulfillment engine 320) generates the order.

In step 416, the centralized healthcare management server system tracks a status of the particular healthcare laboratory service. In some embodiments, a tracking engine (e.g., tracking engine 322) tracks the status.

In some embodiments, the status of the particular healthcare laboratory service is a dynamic status. The dynamic status may be capable of being updated by the centralized healthcare management server system in response to one or more trigger events detected by the centralized healthcare management server system. The dynamic status may include a plurality of different stages of the particular healthcare laboratory service. The trigger events may include transitions between stages. In some embodiments, the centralized healthcare management server system hooks into a service provider system of the particular service provider to detect the one or more trigger events.

In some embodiments, the status of the particular healthcare laboratory service includes a shipping status of a specimen associated with the particular healthcare laboratory service. For example, the specimen may be a blood test shipped to the service provider for toxicology testing.

In step 418, the centralized healthcare management server system notifies the healthcare provider of the status of the particular healthcare laboratory service. In some embodiments, an notification engine (e.g., notification engine 324) provides the notification. For example, the notification engine may generate and provide a notification to a healthcare provider system (e.g., healthcare provider system 104) and/or patient system (e.g., patient system 108).

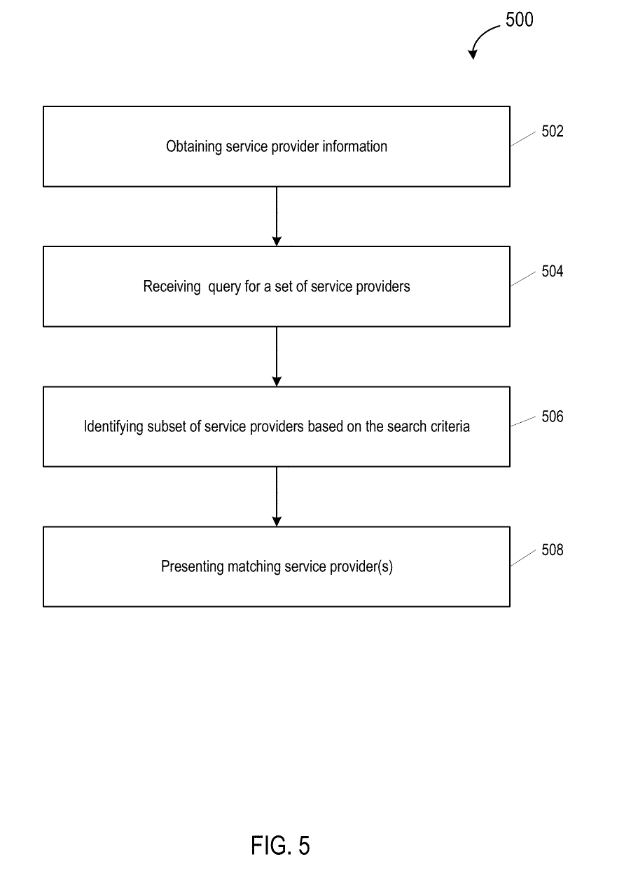

FIG. 5 depicts a flowchart 500 of an example of a method of centralized searching of aggregated service provider information according to some embodiments.

In step 502, a centralized healthcare management server system (e.g., centralized healthcare management server system 102) obtain service provider information (e.g., service provider information 116). The service provider information may be stored in a service provider datastore (e.g., service provider datastore 304).

In step 504, receives a query for a set of service providers. The query may include search criteria. The search criteria may include a desired service provide geolocation, a desired price range of a particular set of one or more healthcare laboratory services, desired range of feedback ratings, service provider times of operation, and/or the like. In some embodiments, a query engine (e.g., query engine 318) receives the query from a healthcare provider system (e.g., healthcare provider system 104) over a communications network (e.g., communications network 110).

In step 506, the centralized healthcare management server system identifies a subset of service providers based on the search criteria. For example, the centralized healthcare management server system may search the service provider information stored in the service provider datastore for service providers matching some or all of the search criteria. In some embodiments, the query engine identifies the subset of service providers.

In step 508, the centralized healthcare management server system presents matching service providers. In some embodiments, a presentation engine (e.g., presentation engine 332) presents the matching service providers (e.g., through a GUI) at least partially generated by the presentation engine.

FIG. 6 depicts an example graphical user interface (GUI) 600 displaying a centralized healthcare marketplace according to some embodiments. As with the other example GUIs described herein, the GUI 600 may be generated at least partially by the centralized healthcare management server system 102 (e.g., by presentation engine 332). For example, the centralized healthcare management server system 102 may provide the server-side code for generating the GUI 600 on a user system (e.g., healthcare provider system 104).

The centralized healthcare marketplace may be used by healthcare professionals such as medical doctors in search of providers of various offerings including laboratory testing, billing services, test results reports, and other resources. Licensed laboratories capable of processing samples or otherwise fulfilling the provider order, can have their entity listed in the marketplace for providing these types of services. Accompanying a laboratory's listing on the marketplace is various metrics, for example, price of service, license identification, location, average turnaround time, and ratings. Some of these metrics can be calculated by the centralized healthcare management server system 102, such as turnaround time and location, others will be representative of the service provider's listing of their service, for example, price, license identification, and hours of service. Feedback based metrics such as customer ratings, can also be accumulated from user input.

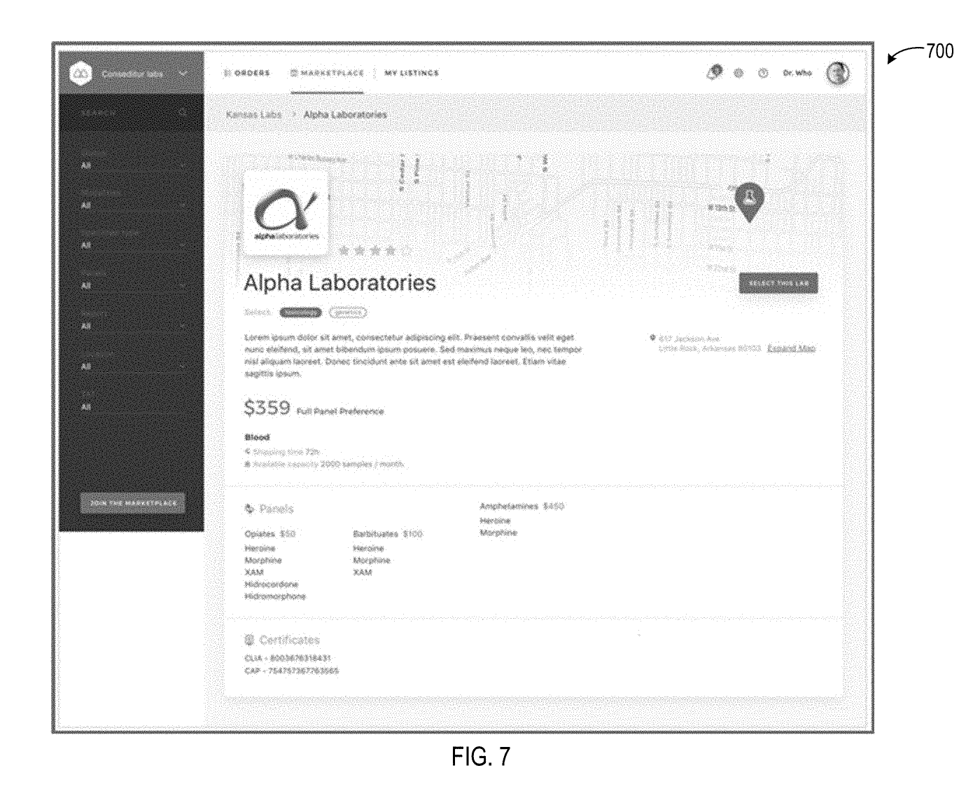

FIG. 7 depicts an example graphical user interface (GUI) 700 displaying an example service offering of a service provider according to some embodiments. For example, the GUI 700 depicts a service provider “Alpha Laboratories,” a full panel service price of “$359,” and other related service provider information.

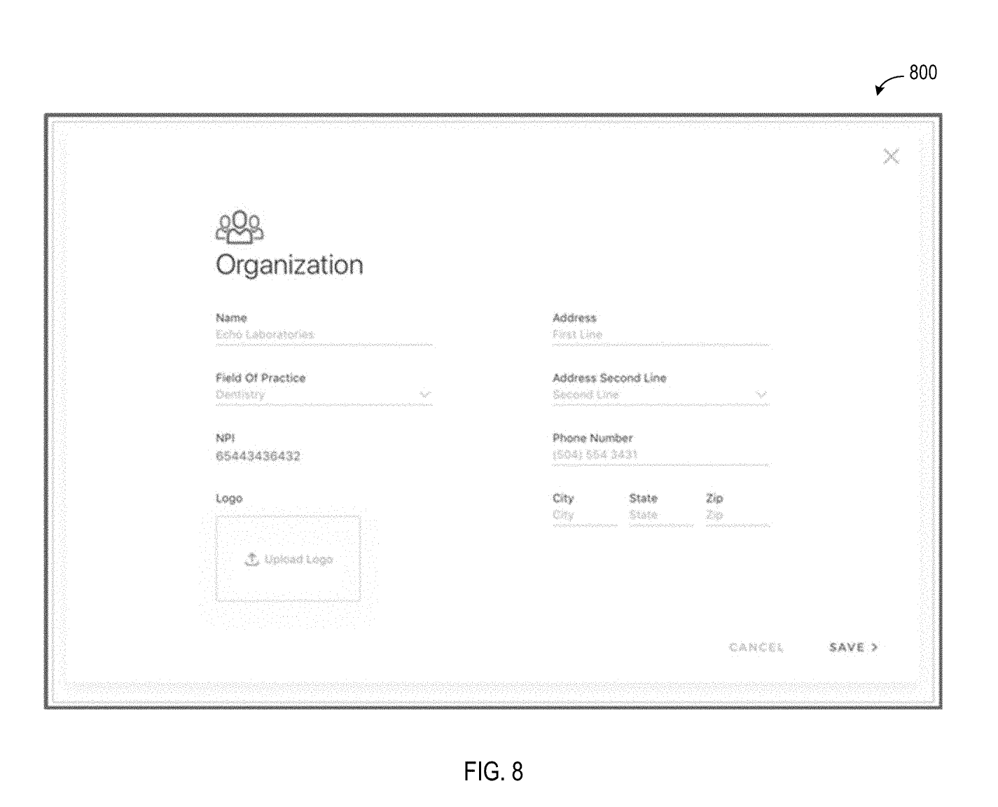

FIG. 8 depicts an example graphical user interface (GUI) 800 displaying a service provider registration screen according to some embodiments. For example, a service provider may provide service provider information during registration and/or update service provider information subsequent to registration. As shown, service provider information may include name, field of practice, national provider identifier (NPI), logo, address, phone number, city, state, zip code, and/or the like.

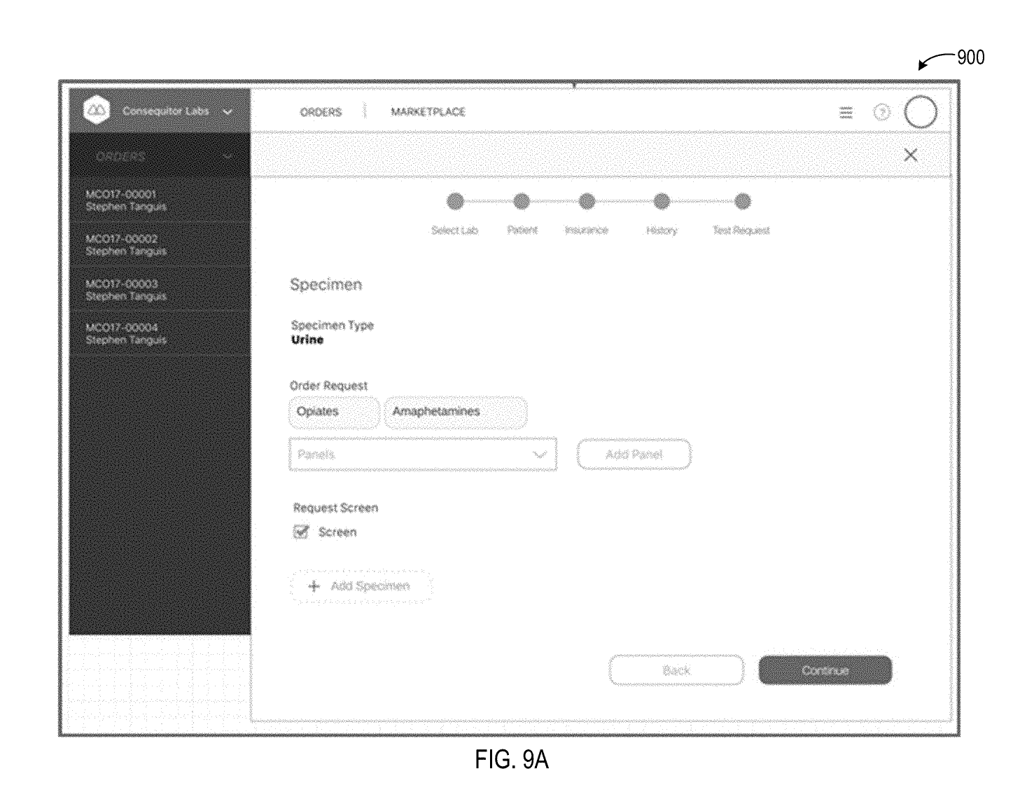

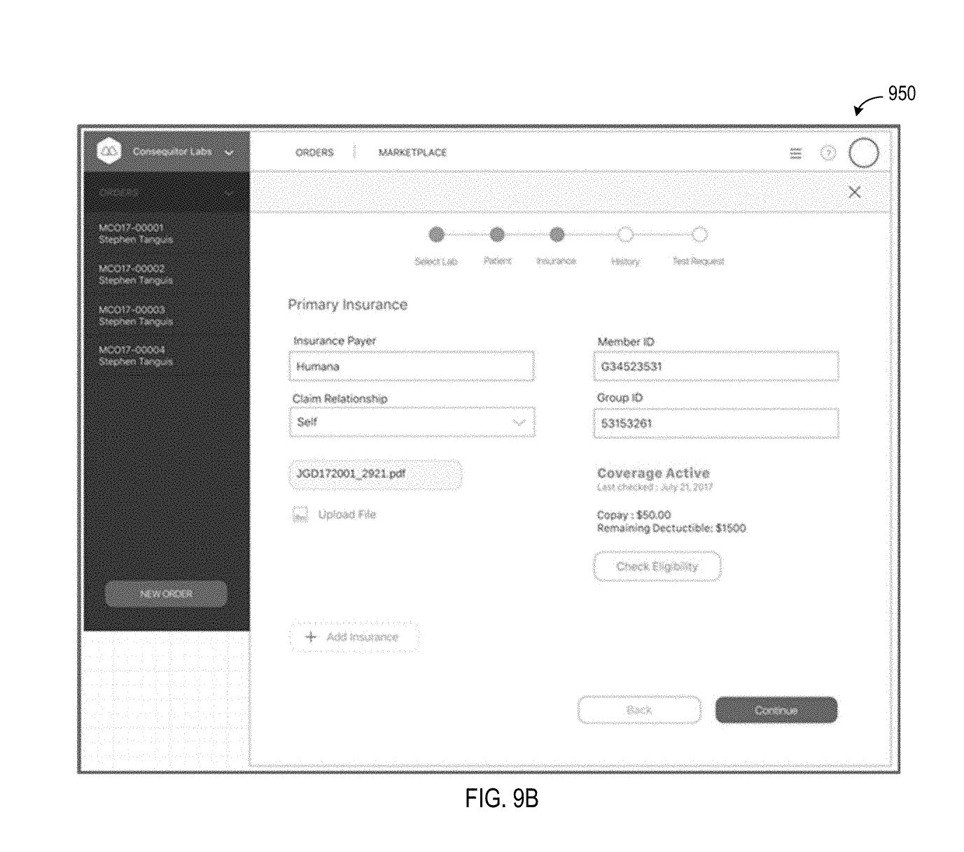

FIGS. 9A-B depicts example graphical user interfaces (GUIs) 900 and 950 displaying an example ordering process according to some embodiments. GUI 900, more specifically, depicts an example order (or, “accessioning”) form that allows a user (e.g., provider) to identifying a specimen, specimen type, order request, panels, and/or the like. The input values may be used to generate an order (e.g., by fulfillment engine 320). GUI 950, more specifically, depicts an example form for checking patient insurance eligibility. For example, a user (e.g., healthcare provider may input payer information, claim relationship, member identifier, group identifier, and retrieve coverage information (e.g., co-pay amount, deductive amount) from the corresponding payer.

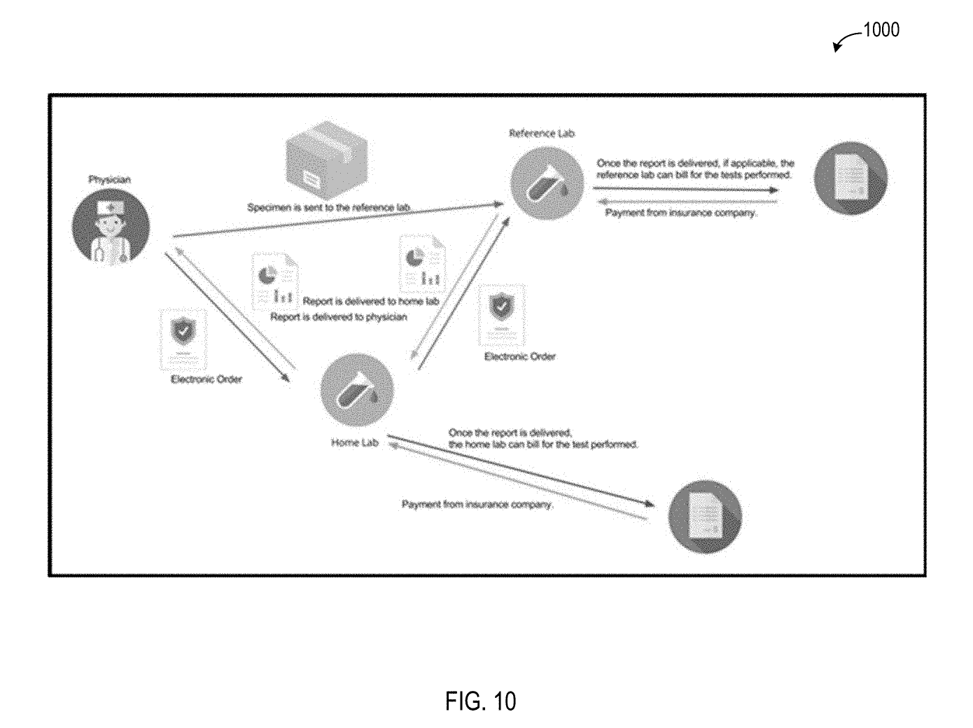

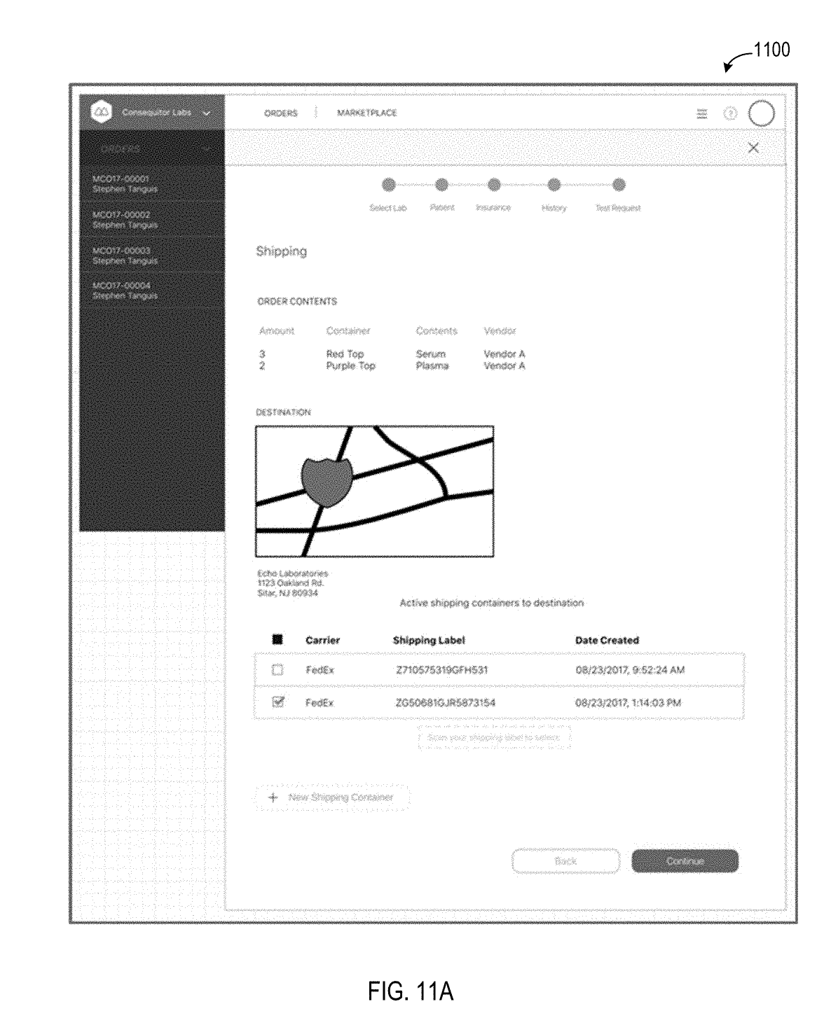

FIG. 10 depicts a flowchart 1000 of an example method of laboratory processing according to some embodiments. An order (e.g., an electronic order) is submitted by the physician to a home lab. A physician may submit a specimen to a reference lab. The home lab may submit the order to a reference lab. A centralized healthcare management server system may generate a report based on results from the reference lab. The report can be delivered to the home lab and/or physician by the centralized healthcare management server system. Once the report is generated and/or delivered, the reference lab may bill (e.g., the payer) for the tests performed, and may receive payment (e.g., from payer). Once the report is delivered, the home lab may bill (e.g., the payer) for the tests performed. The home lab may receive payment from the insurance company.

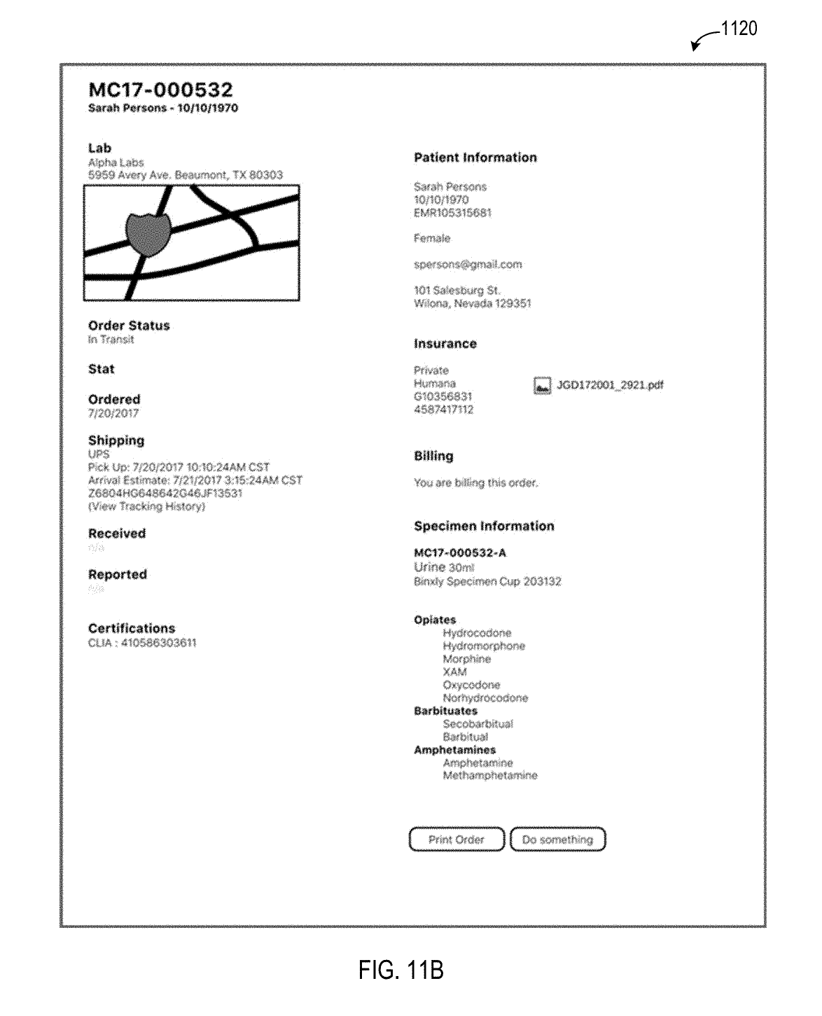

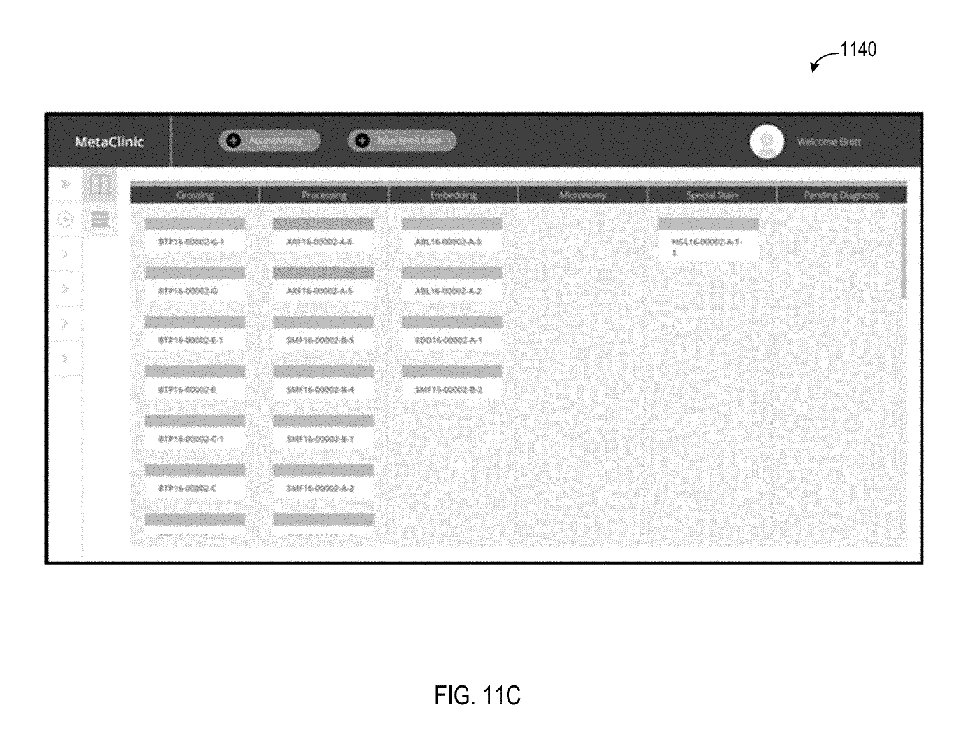

FIG. 11A-C depict example graphical user interfaces (GUIs) 1100, 1120, and 1120, displaying tracking information according to some embodiments. More specifically, GUI 1100 shows shipping information, GUI 1120 shows order status information, and FIG. 1140 shows additional order status information.

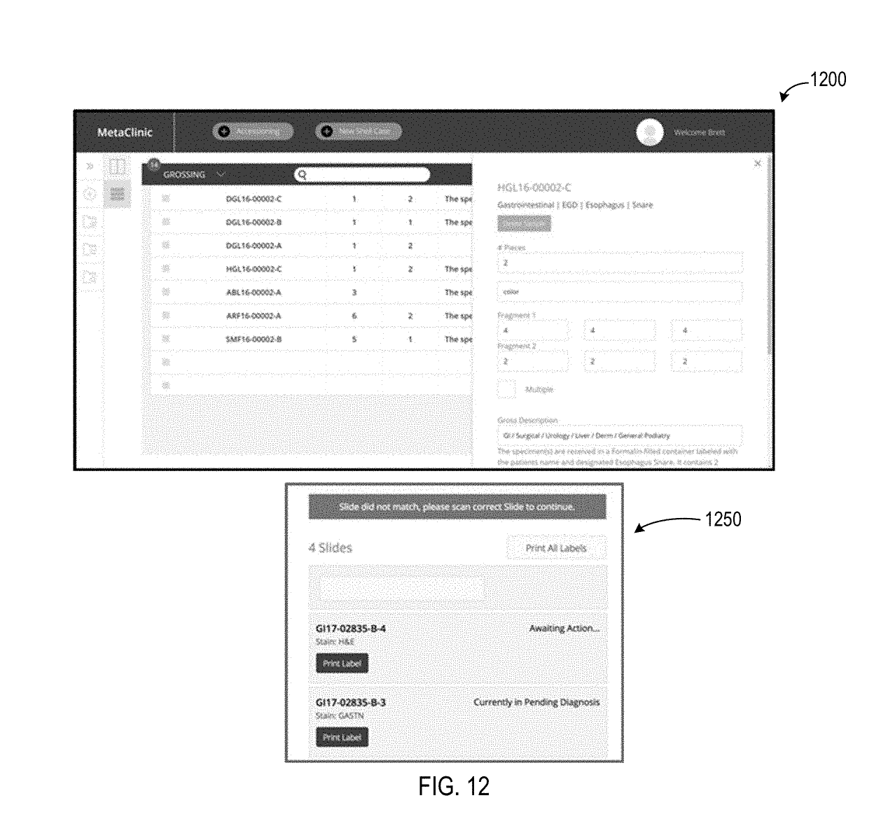

FIG. 12 depicts example graphical user interfaces (GUIs) 1200 and 1250 displaying quality control information according to some embodiments. For example, GUI 1250 depicts an error detected in the information displayed in GUI 1200.

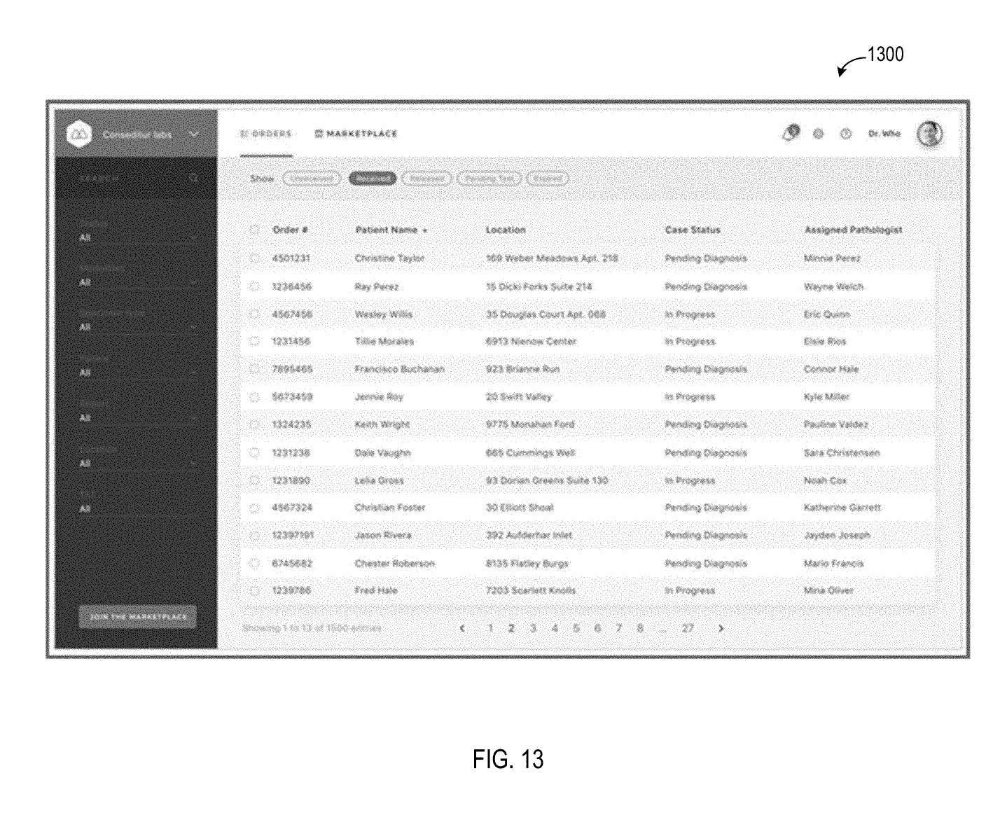

FIG. 13 depicts an example graphical user interface (GUI) 1300 displaying a screen for releasing reports according to some embodiments. For example, the GUI 1300 includes multiples rows of entries include columns for order number, patient name, location, case status, and assigned pathologist. A user (e.g., healthcare provider) may select which reports to release (e.g., for inclusion in a patient electronic medical record).

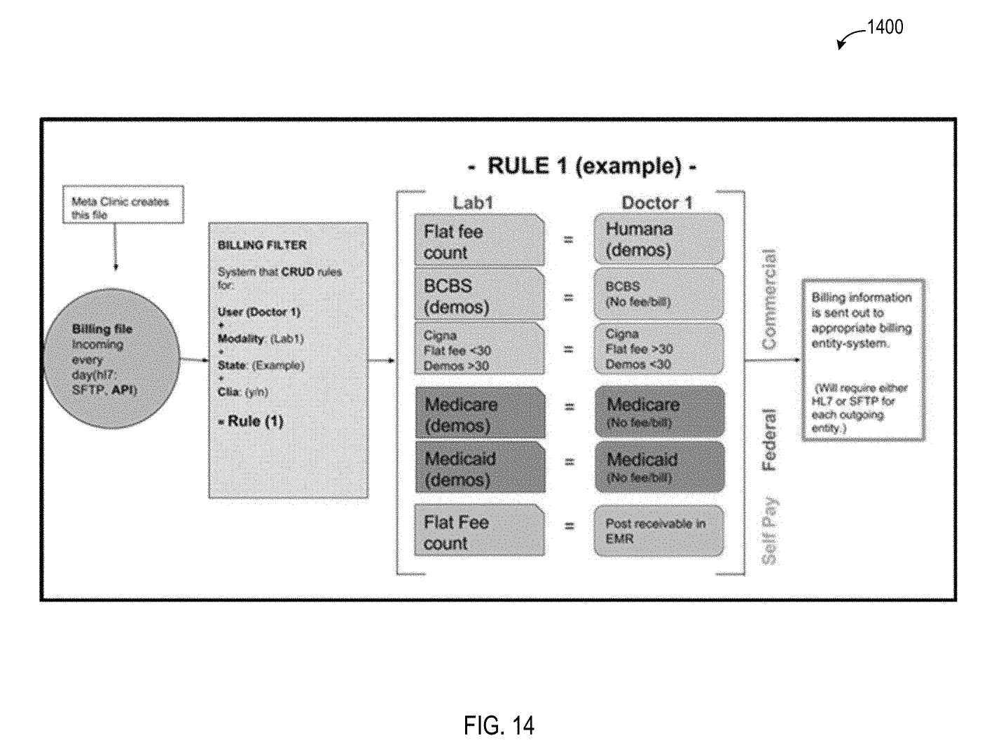

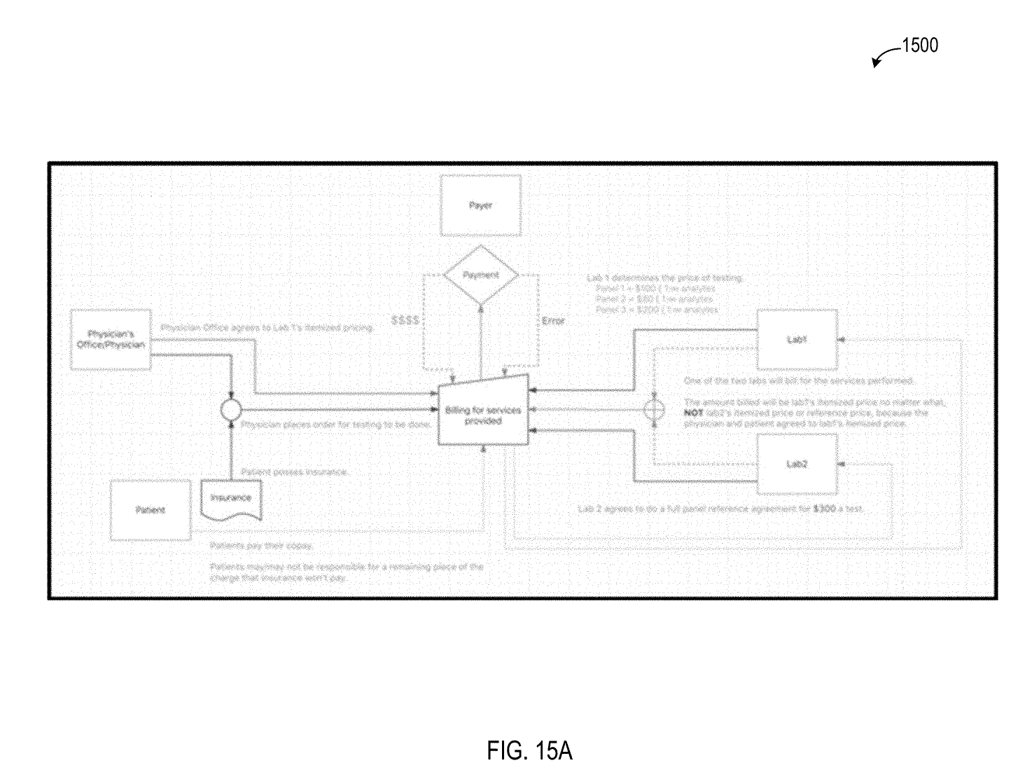

FIG. 14 depicts an example billing rule 1400 according to some embodiments. For example, billing rules may be connected at the point of accessioning to a billing clearinghouse for instant adjudication. We may utilize machine learning to predict the adjudication for the purpose of informing the patient of any potential payment required of them before incurring the cost of the medical procedure.

FIGS. 15A-D depict flowcharts 1500, 1510, 1520 and 1540 of example billing processes and entity relationships according to some embodiments.

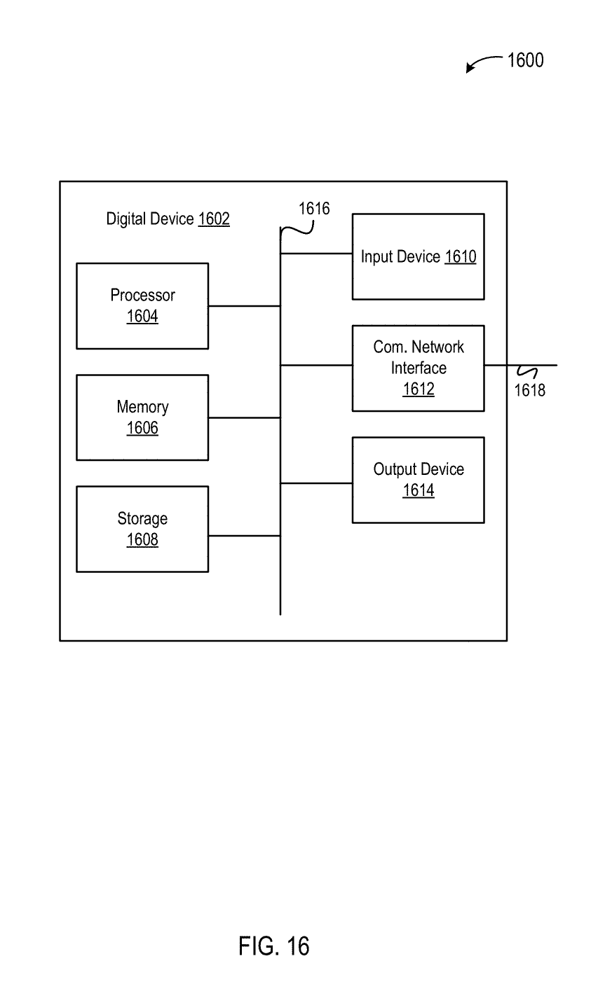

FIG. 16 depicts a diagram 1600 of an example of a computing device 1602. Any of the systems 102-110, and the communication network 112 may comprise an instance of one or more computing devices 1602. The computing device 1602 comprises a processor 1604, memory 1606, storage 1608, an input device 1610, a communication network interface 1612, and an output device 1614 communicatively coupled to a communication channel 1616. The processor 1604 is configured to execute executable instructions (e.g., programs). In some embodiments, the processor 1604 comprises circuitry or any processor capable of processing the executable instructions.

The memory 1606 stores data. Some examples of memory 1606 include storage devices, such as RAM, ROM, RAM cache, virtual memory, etc. In various embodiments, working data is stored within the memory 1606. The data within the memory 1606 may be cleared or ultimately transferred to the storage 1608.

The storage 1608 includes any storage configured to retrieve and store data. Some examples of the storage 1608 include flash drives, hard drives, optical drives, cloud storage, and/or magnetic tape. Each of the memory system 1606 and the storage system 1608 comprises a computer-readable medium, which stores instructions or programs executable by processor 1604.

The input device 1610 is any device that inputs data (e.g., mouse and keyboard). The output device 1614 outputs data (e.g., a speaker or display). It will be appreciated that the storage 1608, input device 1610, and output device 1614 may be optional. For example, the routers/switchers may comprise the processor 1604 and memory 1606 as well as a device to receive and output data (e.g., the communication network interface 1612 and/or the output device 1614).

The communication network interface 1612 may be coupled to a network (e.g., network 110) via the link 1618. The communication network interface 1612 may support communication over an Ethernet connection, a serial connection, a parallel connection, and/or an ATA connection. The communication network interface 1612 may also support wireless communication (e.g., 802.11 a/b/g/n, WiMax, LTE, WiFi). It will be apparent that the communication network interface 1612 may support many wired and wireless standards.

It will be appreciated that the hardware elements of the computing device 1602 are not limited to those depicted in FIG. 16. A computing device 1602 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1604 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A method comprising:
obtaining, by a centralized healthcare management server system, service provider information of each of a plurality of different service providers, each of the service providers capable of providing one or more healthcare laboratory services, the service provider information obtained over a communications network from service provider systems of the plurality of different service providers;
storing, by the centralized healthcare management server system, the service provider information;
calculating, by the centralized healthcare management server system, a service provider score for each of the plurality of different service providers based on the service provider information;
selecting, by the centralized healthcare management server system, a subset of service providers from the plurality of different service providers based on the service provider scores;
providing, by the centralized healthcare management server system, at least a portion of the service provider information for each of the subset of service providers for display through a graphical user interface (GUI), the GUI being at least partially generated by the centralized healthcare management server system;
receiving, by the centralized healthcare management server system, a selection of a particular service provider from the subset of service providers, the selection being received through the graphical user interface from a healthcare provider;
generating, by the centralized healthcare management server system, an order for a particular healthcare laboratory service of the one or more healthcare laboratory services capable of being provided by the particular service provider;
tracking, by the centralized healthcare management server system, a status of the particular healthcare laboratory service; and
notifying, by the centralized healthcare management server system, the healthcare provider of the status of the particular healthcare laboratory service.

2. The method of claim 1, wherein each of the service provider information of the plurality of different service providers includes a respective service provider identifier, a respective healthcare laboratory service identifier for each of the one or more healthcare laboratory services capable of being provided, a respective price for each of the one or more healthcare laboratory services capable of being provided, and a respective service provider geolocation.

3. The method of claim 2, further comprising:
determining, by the centralized healthcare management server system, a respective average turnaround for each of the one or more healthcare laboratory services capable of being provided by the service providers, wherein the service information includes the respective average turnaround time.

4. The method of claim 3, further comprising:
determining, by the centralized healthcare management server system, a feedback rating for at least one of the plurality of different service providers based on feedback provided by one or more healthcare providers through the graphical user interface, wherein the service provider information includes the feedback rating.

5. The method of claim 1, further comprising:
identifying, by the centralized healthcare management server system, a particular subset of service providers from the plurality of different service providers based on search criteria, the search criteria received by the centralized healthcare management server system from the healthcare provider through the graphical user interface.

6. The method of claim 5, wherein the search criteria includes a desired service provide geolocation, a desired price range of a particular set of one or more healthcare laboratory services, desired range of feedback ratings, and service provider times of operation.

7. The method of claim 1, further comprising:
receiving, by the centralized healthcare management server system, service result data from the particular servicer provider of the subset of service providers;
generating, by the centralized healthcare management server system, a report based on the received service result data;
providing, by the centralized healthcare management server system, the report to the healthcare provider over the communication network, the report capable of being viewed through the graphical user interface.

8. The method of claim 1, wherein the status of the particular healthcare laboratory service comprises a dynamic status capable of being updated, by the centralized healthcare management server system, in response to one or more trigger events detected by the centralized healthcare management server system, the dynamic status including a plurality of different stages of the particular healthcare laboratory service.

9. The method of claim 1, wherein the centralized healthcare management server system hooks into a service provider system of the particular service provider to detect the one or more trigger events, the one or more trigger events includes a progression from a first stage of the plurality of different stages of the particular healthcare laboratory service to a second stage of the plurality of different stages of the particular healthcare laboratory service.

10. The method of claim 1, wherein the status of the particular healthcare laboratory service includes a shipping status of a specimen associated with the particular healthcare laboratory service.

11. A centralized healthcare management server system comprising:
one or more processors; and
memory storing instructions that, when executed by the one or more processors, cause the centralized healthcare management server system to perform:
obtaining service provider information of each of a plurality of different service providers, each of the service providers capable of providing one or more healthcare laboratory services, the service provider information obtained over a communications network from service provider systems of the plurality of different service providers;
storing the service provider information;
calculating a service provider score for each of the plurality of different service providers based on the service provider information;
selecting a subset of service providers from the plurality of different service providers based on the service provider scores;
providing at least a portion of the service provider information for each of the subset of service providers for display through a graphical user interface (GUI), the GUI being at least partially generated by the centralized healthcare management server system;
receiving a selection of a particular service provider from the subset of service providers, the selection being received through the graphical user interface from a healthcare provider;
generating an order for a particular healthcare laboratory service of the one or more healthcare laboratory services capable of being provided by the particular service provider;
tracking a status of the particular healthcare laboratory service; and
notifying the healthcare provider of the status of the particular healthcare laboratory service.

12. The system of claim 11, wherein each of the service provider information of the plurality of different service providers includes a respective service provider identifier, a respective healthcare laboratory service identifier for each of the one or more healthcare laboratory services capable of being provided, a respective price for each of the one or more healthcare laboratory services capable of being provided, and a respective service provider geolocation.

13. The system of claim 12, wherein the instruction further cause the system to perform:
determining a respective average turnaround for each of the one or more healthcare laboratory services capable of being provided by the service providers, wherein the service information includes the respective average turnaround time.

14. The system of claim 13, wherein the instruction further cause the system to perform:
determining a feedback rating for at least one of the plurality of different service providers based on feedback provided by one or more healthcare providers through the graphical user interface, wherein the service provider information includes the feedback rating.

15. The system of claim 11, wherein the instruction further cause the system to perform:
identifying a particular subset of service providers from the plurality of different service providers based on search criteria, the search criteria received by the centralized healthcare management server system from the healthcare provider through the graphical user interface.

16. The system of claim 15, wherein the search criteria includes a desired service provide geolocation, a desired price range of a particular set of one or more healthcare laboratory services, desired range of feedback ratings, and service provider times of operation.

17. The system of claim 11, wherein the instruction further cause the system to perform:
receiving service result data from the particular servicer provider of the subset of service providers;
generating a report based on the received service result data;
providing the report to the healthcare provider over the communication network, the report capable of being viewed through the graphical user interface.

18. The system of claim 11, wherein the status of the particular healthcare laboratory service comprises a dynamic status capable of being updated, by the centralized healthcare management server system, in response to one or more trigger events detected by the centralized healthcare management server system, the dynamic status including a plurality of different stages of the particular healthcare laboratory service.

19. The system of claim 11, wherein the centralized healthcare management server system hooks into a service provider system of the particular service provider to detect the one or more trigger events, the one or more trigger events includes a progression from a first stage of the plurality of different stages of the particular healthcare laboratory service to a second stage of the plurality of different stages of the particular healthcare laboratory service.

20. The system of claim 11, wherein the status of the particular healthcare laboratory service includes a shipping status of a specimen associated with the particular healthcare laboratory service.

21. A non-transitory computer readable medium comprising instructions that, when executed, cause one or more processors to perform:
obtaining service provider information of each of a plurality of different service providers, each of the service providers capable of providing one or more healthcare laboratory services, the service provider information obtained over a communications network from service provider systems of the plurality of different service providers;
storing the service provider information;
calculating a service provider score for each of the plurality of different service providers based on the service provider information;
selecting a subset of service providers from the plurality of different service providers based on the service provider scores;
providing at least a portion of the service provider information for each of the subset of service providers for display through a graphical user interface (GUI), the GUI being at least partially generated by the centralized healthcare management server system;
receiving a selection of a particular service provider from the subset of service providers, the selection being received through the graphical user interface from a healthcare provider;
generating an order for a particular healthcare laboratory service of the one or more healthcare laboratory services capable of being provided by the particular service provider;
tracking a status of the particular healthcare laboratory service; and
notifying the healthcare provider of the status of the particular healthcare laboratory service.
